(19) United States
(12) Patent Application Publication
(10) Pub. No.: US 2026/0299462 A1
(43) Pub. Date: Oct. 1, 2026

(54) IMAGE FORMING APPARATUS

(71) Applicant: CANON KABUSHIKI KAISHA, Tokyo (JP)

(72) Inventors: MIKIHIKO HAMADA, Kanagawa (JP); SHUICHI TETSUNO, Kanagawa (JP); SHUNSUKE MATSUSHITA, Kanagawa (JP)

(21) Appl. No.: 19/572,677

(22) Filed: Mar. 19, 2026

(30) Foreign Application Priority Data
Mar. 28, 2025 (JP) 2025-054682

(51) Int. Cl. G03G 15/08; G03G 15/00

(52) U.S. Cl. CPC G03G 15/0865; G03G 15/0862; G03G 15/0863; G03G 15/0889; G03G 15/5016

(57) ABSTRACT

An image forming apparatus includes an image bearing member, a rotatable developer bearing member, a first driving unit that rotationally drives the developer bearing member, a developer storage unit that houses the developer bearing member and stores developer, a rotatable agitation member configured to agitate the developer, a second driving unit that rotationally drives the agitation member, a developer detection unit that detects information about the developer in the developer storage unit, an attachment portion which detachably receives a replenishment container and includes a replenishment port that communicates with the developer storage unit, and a control unit. During a replenishment operation, developer is replenished to the developer storage unit through the replenishment port from the replenishment container while rotation of the developer bearing member and the agitation member is stopped, and the control unit controls the first and second driving units based on the information regarding the developer.

### BACKGROUND

### Field of the Technology

The present disclosure relates to an image forming apparatus for forming an image on a recording medium using an electrophotographic process or the like.

### Description of the Related Art

Generally, an electrophotographic image forming apparatus forms an image on a recording material by transferring a toner image formed on the surface of a photosensitive drum to the recording material. For example, a toner replenishment method has been known as a method of supplying new toner in a case where image formation becomes unable to be sufficiently performed due to the consumption of toner serving as a developer through image formation. The toner replenishment method is a method of newly supplying toner to a developer container without requiring replacement of components if a toner remaining amount becomes low. Japanese Patent Laid-Open No. 2022-27631 describes a configuration of a toner replenishment method (hereinafter, will be referred to as a direct toner replenishment method) in which a toner pack is attached to a developer container in such a manner that a part of the toner pack is exposed to the outside, and the toner stored in the toner pack is collectively replenished into the developer container.

Nevertheless, the configuration described in Japanese Patent Laid-Open No. 2022-27631 has the following issues. The configuration described in Japanese Patent Laid-Open No. 2022-27631 can detect the remaining amount of toner being consumed and the remaining amount of toner after replenishment by a toner remaining amount detection unit, and report the detected toner remaining amount to a user. The toner remaining amount detection unit recognizes the amount of toner in the developer container while agitating toner by an agitation member installed in the developer container. Accordingly, a toner replenishment operation in the configuration described in Japanese Patent Laid-Open No. 2022-27631 involves rotational driving of at least the agitation member.

Accordingly, in Japanese Patent Laid-Open No. 2022-27631, for example, when the driving of the agitation member is performed in the developer container in which toner is not filled, such as the time when an apparatus is brand-new, breakage of components may occur. In particular, in a case where the agitation member and another rotatable member are driven together, the risk of breakage of the rotatable member increases.

### SUMMARY

The present disclosure is directed to desirably executing toner replenishment into a developer container while reducing breakage of a component.

The means for solving the above-described issues is provided by the image forming apparatus according to the present application. In summary, representative configurations of the present disclosure are as follows. An image forming apparatus includes an image bearing member, a rotatable developer bearing member configured to supply a developer to the image bearing member, a first driving unit configured to rotationally drive the developer bearing member, a developer storage unit in which the developer bearing member is arranged and the developer is stored, a rotatable agitation member that is arranged in the developer storage unit, and configured to agitate the developer, a second driving unit configured to rotationally drive the agitation member, a developer detection unit arranged in the developer storage unit, and configured to detect information regarding the developer stored in the developer storage unit, an attachment portion comprising a replenishment port that communicates with the developer storage unit and configured to detachably receive a replenishment container, and a control unit configured to control the first driving unit and the second driving unit, wherein the control unit is configured to execute a replenishment operation for replenishing the developer to the developer storage unit, wherein, during the replenishment operation, the developer is replenished to the developer storage unit through the replenishment port from the replenishment container attached to the attachment portion, wherein the replenishment operation is executed in a state in which rotation of the developer bearing member and the agitation member is stopped, without performing a rotational operation of the developer bearing member and the agitation member, and wherein the control unit is configured, during the replenishment operation, to control the first driving unit and the second driving unit based on the information regarding the developer.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming apparatus according to a first embodiment.

FIG. 2 is a perspective view of an agitation member according to the first embodiment.

FIG. 3 is a perspective view of the image forming apparatus according to the first embodiment.

FIGS. 4A and 4B are respectively a perspective view and a front view of a process cartridge and a toner pack according to the first embodiment.

FIG. 5 is a perspective view of the toner pack according to the first embodiment.

FIG. 6 is a schematic plan view illustrating an optical path of laser light of an exposure unit according to the first embodiment.

FIGS. 7A to 7C are diagrams illustrating a toner remaining amount detection sensor according to the first embodiment.

FIG. 8 is a diagram illustrating an example of a circuitry configuration of the toner remaining amount detection sensor according to the first embodiment.

FIG. 9 is a block diagram illustrating a control system of the image forming apparatus according to the first embodiment.

FIGS. 10A and 10B are diagrams illustrating voltage waveforms at toner levels FULL and LOW according to the first embodiment.

FIG. 11 is a diagram illustrating a voltage waveform at the time of toner stop filling according to the first embodiment.

FIGS. 12A to 12D are diagrams each illustrating a cross-sectional image, a transmissive image and a voltage waveform when a phase of the agitation member is changed according to the first embodiment.

FIG. 13 is a flowchart illustrating operations to be performed before and after the toner stop filling operation according to the first embodiment.

FIG. 14 is a diagram illustrating a voltage waveform, cross-sectional images, and transmissive images according to a second embodiment.

FIG. 15 is a diagram illustrating a voltage waveform, a cross-sectional image, and a transmissive image according to a third embodiment.

### DESCRIPTION OF THE EMBODIMENTS

Hereinafter, embodiments for carrying out the present disclosure will be described illustratively and in detail based on embodiments with reference to the drawings. However, the dimensions, materials, shapes, relative arrangement, and the like of the components described in these embodiments are to be appropriately modified depending on the configuration of the apparatus to which the present disclosure is applied and various conditions. That is, it is not intended that the scope of the present disclosure be limited to the following embodiments.

### 1. Image Forming Apparatus

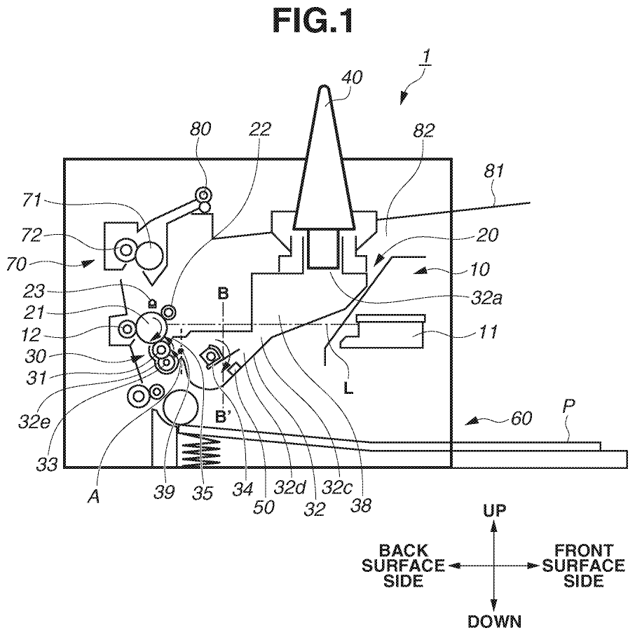

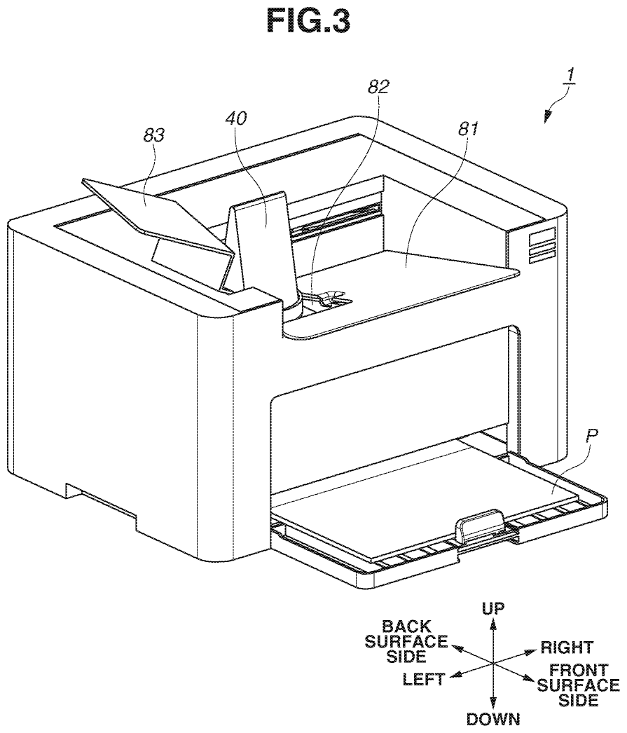

FIG. 1 is a schematic cross-sectional view schematically illustrating a configuration of an image forming apparatus 1 according to the first embodiment of the present disclosure. FIG. 3 is a perspective view of the image forming apparatus 1 according to the present embodiment. The image forming apparatus 1 is a monochrome printer that forms an image on a recording material P based on image information input from an external device.

FIG. 1 illustrates a state in which the image forming apparatus 1 is installed on a horizontal surface, as a normally assumed installation state of the image forming apparatus 1, and directions on the plane of the drawing are defined as follows. The up-down direction on the drawing is a vertical direction (gravity direction), and the upward direction and the downward direction on the drawing will be referred to as an “upward direction” and a “downward direction”, respectively. The leftward direction on the drawing will be referred to as a back direction (direction from the front surface side to the back side of the apparatus), and the rightward direction on the drawing will be referred to as a front direction (direction from the back surface side to the front side of the apparatus). In addition, the frontward direction on the drawing (the direction from the back side of the drawing toward the front side of the drawing, which is perpendicular to the plane of the drawing) will be referred to as a left direction, and a rear direction (the direction from the front side of the drawing toward the back side of the drawing, which is perpendicular to the plane of the drawing) will be referred to as a right direction.

An image forming unit 10 includes a scanner unit 11, an electrophotographic process cartridge 20, and a transfer roller 12 that transfers, to the recording material P, a toner image formed on a photosensitive drum 21 serving as an image bearing member that is provided in the process cartridge 20.

The process cartridge 20 includes the photosensitive drum 21, a charging roller 22, a pre-exposure device 23, and a development device 30 including a development roller 31 (developer bearing member) arranged around the photosensitive drum 21. An image forming apparatus to which the technique of the present disclosure can be applied is not limited to an image forming apparatus having the same basic configuration as that of the image forming apparatus 1 described in the first embodiment. For example, the image forming apparatus may be a color laser printer that includes a plurality of process cartridges 20 serving as an image forming unit, and an intermediate transfer member such as an intermediate transfer belt, and forms a color image on the recording material P using toners of a plurality of colors.

The process cartridge 20 according to the present embodiment is configured to be replaceable by being attached to and detached from the image forming apparatus 1 by the user. Alternatively, the process cartridge 20 may be fixed to the image forming apparatus 1 with a configuration that does not assume attachment and detachment by the user. That is, the process cartridge 20 may be configured as a process unit that can be regarded as a part of an apparatus main body.

The process cartridge 20 is configured to be easily attached to or detached from the image forming apparatus 1 by an attachment guide and a positioning member that are provided on one or both of the image forming apparatus 1 and the process cartridge 20.

In addition, the image forming apparatus 1 includes the transfer roller 12 serving as a transfer unit, and a fixing device 70 serving as a fixing unit (fuser). The transfer roller 12 is a roller-shaped transfer member arranged in contact with the surface of the photosensitive drum 21. The fixing device 70 includes, for example, a fixing roller (fixing member) 71 having a built-in halogen lamp serving as a heating unit, and a pressing roller (pressing member) 72 in pressure contact with the fixing roller 71. A fixing nip is formed between the fixing roller 71 and the pressing roller 72. The fixing device 70 may be, for example, an induction heater (IH) fixing device that uses an induction heating coil as a heating unit, or a ceramic heater in which a pattern of a heating resistor is printed on a ceramic substrate may be used as a heating unit. In addition, fixing member 71 may be a cylindrical film, for example. The fixing member 71 and the pressing member 72 may be endless members (fixing belts) stretched around a plurality of rollers.

Furthermore, the image forming apparatus 1 includes a control unit 90 that governs the control of the entire image forming apparatus 1, and an operation panel 300 serving as an operation unit. The operation panel 300 includes a display unit 301 for displaying information to an operator such as a user or a service personnel under the control of the control unit 90, and an input unit 302 for inputting information to the control unit 90 in accordance with an operation performed by the operator. The display unit 301 includes a liquid crystal panel. The input unit 302 includes a touch panel structure of the liquid crystal panel, and physical keys such as a print execution button.

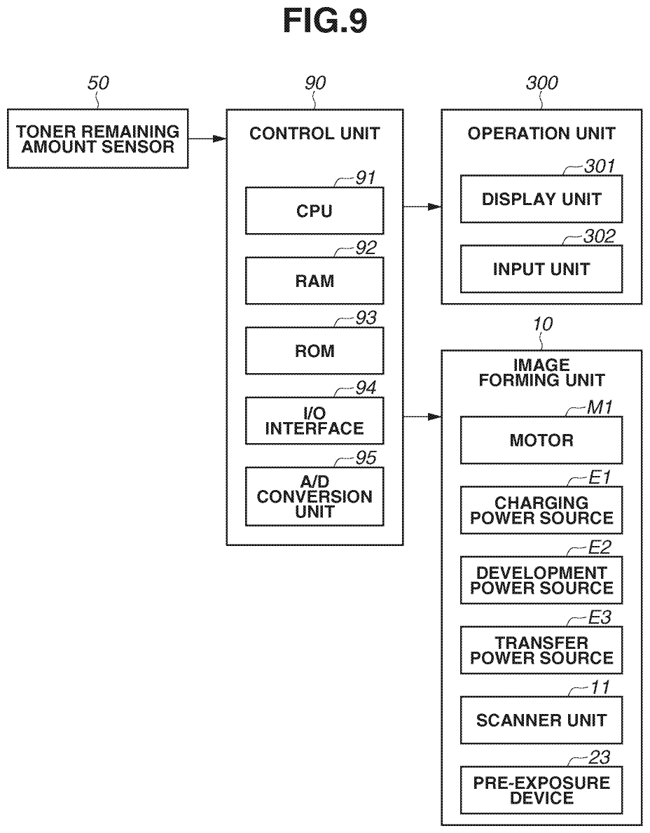

The photosensitive drum 21 serving as an image bearing member is a photosensitive member formed into a cylindrical shape. The photosensitive drum 21 according to the present embodiment includes a photosensitive layer formed of a negatively charged organic photosensitive member on a drum-shaped base member made of aluminum. In addition, the photosensitive drum 21 is rotationally driven in a predetermined direction (clockwise direction in FIG. 1) at a predetermined process speed by a drive motor M1 illustrated in FIG. 9.

The charging roller 22 serving as a charging member comes into contact with the photosensitive drum 21 with predetermined pressure contact force, and forms a charging unit. In addition, a charging power source E1 serving as a charging voltage application unit applies a desired charging voltage, whereby the surface of the photosensitive drum 21 is uniformly charged to a predetermined potential. In the present embodiment, the photosensitive drum 21 is charged to a negative polarity by the charging roller 22. Accordingly, the charging roller 22 uniformly performs charging processing to charge the surface of the photosensitive drum 21 to a predetermined potential with a predetermined polarity (negative polarity in the first embodiment). In the first embodiment, a charging voltage of −1400 V is applied to the charging roller 22 in such a manner that a pre-exposure potential VD (dark portion potential) that is a surface potential of the photosensitive drum 21 after the charging processing becomes −800 V. In the first embodiment, a direct-current voltage is used as a charging voltage, but the charging voltage is not limited to this, and a vibration voltage obtained by superimposing a direct-current voltage and an alternating-current voltage may be used as a charging voltage. To cause stable electric discharge in the charging unit, the pre-exposure device 23 neutralizes the surface potential of the photosensitive drum 21 before the photosensitive drum 21 enters the charging unit.

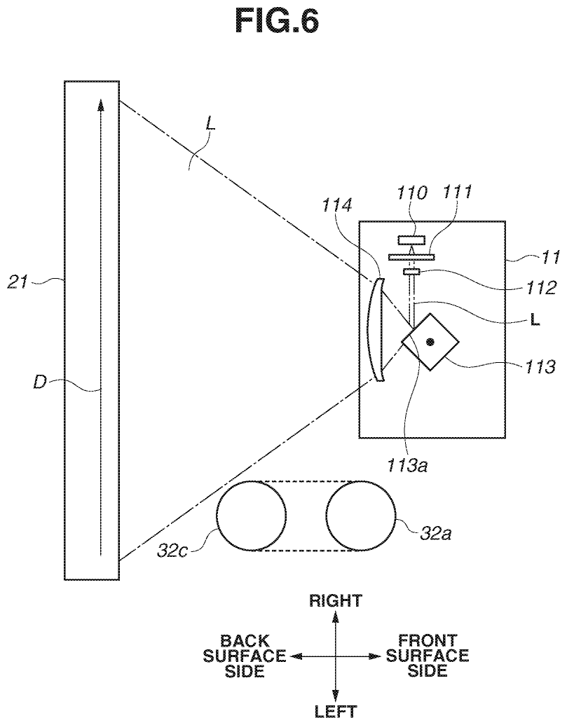

As illustrated in FIG. 6, the scanner unit 11 serving as an exposure unit performs scanning exposure on the surface of the photosensitive drum 21 by irradiating the photosensitive drum 21 with laser light corresponding to image information that has been input from an external device, using a polygonal mirror (deflector) 113. The exposure forms an electrostatic latent image corresponding to the image information on the surface of the photosensitive drum 21. In the first embodiment, the scanner unit 11 includes a laser scanner unit. In the first embodiment, the scanner unit 11 emits laser light to the surface of the photosensitive drum 21 by an amount of 0.45 μJ/cm², for example, in such a manner that a post-exposure potential VL (bright portion potential) that is a potential of the surface of the photosensitive drum 21 after the photosensitive drum 21 is irradiated with light from the scanner unit 11 becomes −100 V. The scanner unit 11 is not limited to a laser scanner device, and a light-emitting diode (LED) exposure device including an LED array in which a plurality of LEDs is arrayed along a longer side direction of the photosensitive drum 21, for example, may be employed.

The development device 30 includes a developer container 32 (frame body) serving as a developer storage unit storing a developer, the development roller 31 serving as a developer bearing member bearing a developer, and a supply roller 33 serving as a developer supply member that comes into contact with the development roller 31 and can supply a developer to the development roller 31. Toner serving as a developer that is stored in the developer container 32 is applied by the supply roller 33 to the surface of the development roller 31. The developer container 32 includes a development chamber 32e in which the development roller 31 and the supply roller 33 are arranged, and a toner storage chamber 32d that is communicated with the development chamber 32e and stores toner to be supplied to the development chamber 32e. The developer container 32 is provided with a protruding portion A (illustrated in FIG. 1) for storing toner to be supplied to the development roller 31 and the supply roller 33 in the development chamber 32e. A boundary portion between the toner storage chamber 32d and the development chamber 32e that is located at a position corresponding to the protruding portion A will be referred to as a development opening portion 39. The supply roller 33 need not necessarily be provided as long as toner can be sufficiently supplied to the development roller 31.

According to the present embodiment, the development method used by the development device 30 is a contact development method. That is, a toner layer borne on the development roller 31 comes into contact with the photosensitive drum 21 at a development portion where the photosensitive drum 21 and the development roller 31 face each other. Alternatively, the configuration of the present embodiment may be applied to noncontact development in which the photosensitive drum 21 and the development roller 31 are not in contact with each other at the development portion where the photosensitive drum 21 and the development roller 31 face each other.

A development voltage is applied to the development roller 31 by a development power source E2 serving as a development voltage application unit. In the first embodiment, a development voltage of −400 V is applied to the development roller 31. Then, toner charged to the same polarity as a charging polarity of the photosensitive drum 21 adheres to a region (exposed portion, image portion) on the photosensitive drum 21 where the absolute value of the potential has been decreased by exposure after uniform charging (reversal development method). The charged toner does not adhere to a region (unexposed portion, non-image portion) where exposure is not performed and the surface potential remains at the pre-exposure potential VD.

In the present embodiment, toner having an average particle diameter of about 6 micrometers (μm) and a negative polarity as a normal charging polarity is used. As an example of toner according to the present embodiment, polymerized toner produced by a polymerization method is employed. In addition, the toner according to the present embodiment is a so-called non-magnetic single-component developer that does not contain a magnetic component, and is to be borne by the development roller 31 mainly by intermolecular force or electrostatic force (image force).

Nevertheless, a single-component developer containing a magnetic component may be used. In addition, a single-component developer may contain additives (for example, wax or silica fine particles) for adjusting the fluidity and charging performance of the toner, aside from toner particles. Moreover, a two-component developer containing non-magnetic toner and a carrier having magnetism may be used as a developer. In the case of using a developer having magnetism, a cylindrical development sleeve in which a magnet is arranged, for example, is used as a developer bearing member.

A development blade 35 regulates the amount of toner to be borne by the development roller 31. The toner supplied to the surface of the development roller 31 is uniformly thinned when it passes through a portion that faces the development blade 35 in accordance with the rotation of the development roller 31, and is charged to a negative polarity by frictional charging.

In addition, an agitation member 34 is rotatably provided inside the toner storage chamber 32d of the developer container 32. Furthermore, a toner remaining amount detection sensor (developer remaining amount detection unit) 50 serving as an optical detection unit is provided on the inner wall of the toner storage chamber 32d. The toner remaining amount detection sensor 50 has an optical path for detection light inside the toner storage chamber 32d, and detects the amount of toner stored in the toner storage chamber 32d based on the amount of detection light passing through the optical path. The details of the configuration of the toner remaining amount detection sensor 50 will be described below in the section of a detection method for a toner remaining amount.

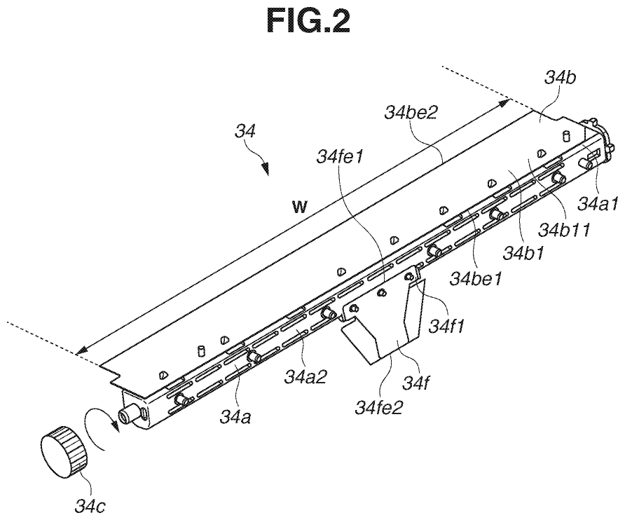

FIG. 2 is a schematic perspective view illustrating a configuration of the agitation member 34. The agitation member 34 includes an agitation shaft (rotatable member) 34a extending in the longer side direction, a blade portion (first sheet) 34b extending outward in a radial direction from the agitation shaft 34a, and a cleaning member (second sheet) 34f extending outward in the radial direction from the agitation shaft 34a at a position different from the blade portion 34b. The cleaning member 34f is provided to clean the toner remaining amount detection sensor 50. In the present embodiment, the cleaning member 34f is provided at a position located 90° downstream, in the rotational direction of the agitation shaft 34a, relative to the blade portion 34b.

Specifically, the agitation shaft 34a has a first attachment surface 34a1 extending in the direction of the rotational axis, and a second attachment surface 34a2 extending in the direction of the rotational axis at a position different from the first attachment surface 34a1 around the rotational axis. The first attachment surface 34a1 and the second attachment surface 34a2 are two neighboring surfaces of four surfaces arranged in the rotational direction of the agitation shaft 34a having a rectangular cross-section, and are surfaces having perpendicular lines (normal lines) extending in directions orthogonal to each other.

The blade portion (first sheet) 34b1 includes an attachment portion (first attachment portion) 34b11 that is in contact with the first attachment surface 34a1. The blade portion 34b1 has one end portion (first end portion) 34be1 in the direction orthogonal to the rotational axis that is fixed to the agitation shaft 34a as a part of the attachment portion 34b11, and another end portion (second end portion) 34be2 that is a free end and can contact the inner wall surface of the toner storage chamber 32d.

The cleaning member (second sheet) 34f includes an attachment portion (second attachment portion) 34f1 that is in contact with the second attachment surface 34a2. The cleaning member 34f has one end portion (third end portion) 34fe1 in the direction orthogonal to the rotational axis that is fixed to the agitation shaft 34a as a part of the attachment portion 34f1, and another end portion (fourth end portion) 34fe2 that can contact the toner remaining amount detection sensor 50. More specifically, the cleaning member 34f is configured to clean the toner remaining amount detection sensor 50 by being in contact with the optical path surface of the toner remaining amount detection sensor 50, which forms an optical path for detection light in the toner storage chamber 32d.

When viewed in the direction of the rotational axis of the agitation shaft 34a, a length of the blade portion 34b that is measured along a direction in which the blade portion 34b extends from the attachment portion 34b1 to its end portion is longer than a length of the cleaning member 34f that is measured along a direction in which the cleaning member 34f extends from the attachment portion 34f1 to its end portion. In addition, in the longer side direction that corresponds to the direction of the rotational axis of the agitation shaft 34a, the width of the cleaning member 34f is narrower than a width of the blade portion 34b. That is, while the cleaning member 34f is provided by a width corresponding to a longer-side-direction width of the toner remaining amount detection sensor 50, the blade portion 34b is provided by a width corresponding to a longer-side-direction width of the toner storage chamber 32d. In addition, a longer-side-direction width of the blade portion 34b is narrower than a longer-side-direction width of the development opening portion 39, and a shorter-side-direction length of the blade portion 34b (length of the blade portion 34b that is measured along a direction in which the blade portion 34b extends when viewed in the direction of the rotational axis) is a length that allows the blade portion 34b to enter the development chamber 32e via the development opening portion 39.

The agitation member 34 is rotated about the agitation shaft 34a as its rotational center by the driving of the drive motor M1 serving as a first driving unit via a gear 34c.

The blade portion 34b of the agitation member 34 according to the present embodiment is made of polycarbonate having a thickness of 180 μm, such that the blade portion is configured to be substantially flexible. The blade portion 34b agitates toner in the developer container 32 while flexing and returning to an original shape in conformity with the inner wall shape of the developer container 32. The longer side direction width W of the blade portion 34b of the agitation member 34 is set to a width narrower than the longer side direction width of the development opening portion 39, and the blade portion 34b can enter the development opening portion 39. The blade portion 34b also has a function of sending toner via the development opening portion 39 toward the development chamber 32e in which the development roller 31 and the supply roller 33 are arranged.

In addition, the cleaning member 34f in the present embodiment has a function of preventing toner that has fallen onto the toner remaining amount detection sensor 50 from contaminating the optical path in order to reduce the situation where the accuracy of toner remaining amount detection cannot be ensured. As the cleaning member 34f in the present embodiment, a cleaning member that is made of a polyimide sheet having high abrasion resistance and a thickness of 200 μm is used so that it can sufficiently withstand repetitive rubbing against the optical path surface of the toner remaining amount detection sensor 50.

### 2. Image Formation Operation

An image forming operation of the image forming apparatus 1 will be described with reference to FIG. 1.

If a command is input to the control unit 90 of the image forming apparatus 1, a print job is started. Based on image information input from an external computer or the like that is connected to the image forming apparatus 1, an image formation process P2 is executed by the image forming unit 10. Before and after the image formation process P2, a pre-rotation process P1 as a preparation process for image formation and a post-rotation process P3 as a postprocessing process are generally provided.

In the pre-rotation process P1, the drive motor M1, the scanner unit 11, various high-voltage power sources E1, E2, and E3, and the fixing unit 70 are started up and stabilized. When each unit has been started, i.e., at a time point at which each unit becomes able to execute image formation, or is expected to become able to execute image formation, the pre-rotation process P1 ends, and the image formation process P2 is started.

In the image formation process P2, based on the input image information, the scanner unit 11 emits laser light L (refer to FIG. 1) toward the photosensitive drum 21. At this time, the photosensitive drum 21 is preliminarily charged by the charging roller 22, and an electrostatic latent image is formed on the photosensitive drum 21 by being irradiated with the laser light L. Thereafter, the electrostatic latent image is developed by the development roller 31, and a toner image is formed on the photosensitive drum 21.

Concurrently with the image formation process P2, a feeding unit 60 conveys the recording material P toward a transfer nip formed by the transfer roller 12 and the photosensitive drum 21. A transfer voltage is applied to the transfer roller 12 by a transfer power source E3 serving as a transfer voltage application unit, and the toner image borne on the photosensitive drum 21 is transferred onto the recording material P. In the first embodiment, a transfer voltage of +1500 V is applied to the transfer roller 12.

The recording material P onto which the toner image has been transferred is conveyed to the fixing unit 70, and the toner image is heated and pressed when the recording material P passes through a nip portion between the fixing roller 71 and the pressing roller 72 of the fixing unit 70.

Accordingly, toner particles melt and then solidify, whereby the toner image is fixed to the recording material P.

On the other hand, toner (transfer residual toner) remaining on the photosensitive drum 21 without being transferred to the recording material P at a transfer portion TS at the time of a transfer process is removed from the surface of the photosensitive drum 21 as follows. On the other hand, the recording material P on which the toner image has been formed and which has passed through the fixing unit 70 is discharged to the outside of the image forming apparatus 1 by a discharge roller pair 80 serving as a discharge unit, and stacked on a discharge tray 81 serving as a stacking portion that is formed in an upper part of the image forming apparatus 1. After all of the recording materials P destined for the discharge tray 81 have been discharged, or after the image formation process P2 has been ended, the image forming apparatus 1 transitions to the post-rotation process P3.

In the post-rotation process P3, the shutdown of various high-voltage power sources is performed, and the rotation of the fixing unit 70 is performed at lower temperature than the temperature used during sheet-passage temperature control or in a state where the temperature control is off to equalize a temperature difference between a sheet-passing portion and a non-sheet-passing portion.

### 3. Cleaner-Less Toner Collection

Toner (transfer residual toner) remaining on the photosensitive drum 21 without being transferred to the recording material P at the time of the transfer process is removed from the surface of the photosensitive drum 21 as follows.

The static electricity is discharged from the surface of the photosensitive drum 21 by the pre-exposure device 23 in such a manner that the surface potential becomes approximately 0 V after the photosensitive drum 21 passes through the transfer portion, and then, the photosensitive drum 21 enters the charging unit. The pre-exposure device 23 performs static elimination by emitting light to the entire region of the surface of the photosensitive drum 21, for example. Toner (hereinafter, will be referred to as transfer residual toner) remaining on the photosensitive drum 21 even after the photosensitive drum 21 passes through the transfer portion includes toner charged to a positive polarity and toner charged to a negative polarity but not having sufficient electric charge in a mixed manner. The transfer residual toner is charged to a negative polarity in the charging unit by electric discharge from the charging roller 22.

The transfer residual toner charged to a negative polarity in the charging unit reaches the development portion in accordance with the rotation of the photosensitive drum 21. Here, an electrostatic latent image corresponding to image data is formed on the surface of the photosensitive drum 21 that has reached the development portion. The transfer residual toner adhering to the unexposed portion (non-image portion) on the photosensitive drum 21 moves at the development portion from the photosensitive drum 21 to the development roller 31 by a potential difference between the pre-exposure potential VD on the photosensitive drum 21 and the development voltage, and is collected to the development device 30.

The toner collected to the development device 30 is mixed with the toner in the development device 30, and re-used for image formation.

In this manner, the image forming apparatus 1 according to the present embodiment employs a configuration (simultaneous development-and-cleaning method) of collecting the transfer residual toner on the photosensitive drum 21 that has not been transferred at the transfer portion to the recording material P serving as a transfer material, to the developer container 32 by the development roller 31. In addition, the image forming apparatus 1 according to the present embodiment employs a cleaner-less method not including a cleaning member for removing transfer residual toner from the photosensitive drum 21.

In the simultaneous development-and-cleaning method, transfer residual toner is collected to the developer container 32 and repeatedly used for image formation. Nevertheless, the control according to the present embodiment can also be applied to an image forming apparatus that removes transfer residual toner using a cleaning member.

On the other hand, the transfer residual toner adhering to the exposed portion (image portion) on the photosensitive drum 21 at the time point at which the photosensitive drum 21 reaches the development portion does not move from the photosensitive drum 21 to the development roller 31 at the development portion. This is because the transfer residual toner charged to a normal polarity remains in the exposed portion since a post-exposure potential is a potential of a polarity (positive polarity) opposite to the normal polarity of the toner based on the potential (development voltage) of the development roller 31. The transfer residual toner remaining in the exposed portion becomes a part of a toner image to be developed at the development portion, and is transferred onto the recording material P at the transfer portion, thereby being removed from the surface of the photosensitive drum 21.

### 4. Control Configuration of Image Forming Apparatus

FIG. 9 is a block diagram illustrating a control configuration of the image forming apparatus 1. The control unit 90 serving as a control unit of the image forming apparatus 1 includes a central processing unit (CPU) 91 serving as an arithmetic device, a random access memory (RAM) 92 to be used as a work area of the CPU 91, and a read-only memory (ROM) 93 serving as a storage unit storing various programs. The control unit 90 also includes an input-output (I/O) interface 94 serving as an input-output port connected with an external device, and an analog-to-digital (A/D) conversion unit 95 that converts an analog signal into a digital signal.

The toner remaining amount detection sensor 50 is connected to an input side of the control unit 90.

The operation unit 300 and the image forming unit 10 are connected to the control unit 90, and the operation unit 300 includes the display unit 301 that can display various setting screens, and the input unit 302 such as physical keys. The display unit 301 includes a liquid crystal panel, for example. The image forming unit 10 includes the drive motor M1 serving as a drive source for driving the photosensitive drum 21, the development roller 31, the supply roller 33, the agitation member 34, and the like. In the present embodiment, the drive motor M1 is provided as a common drive source serving as a driving unit that drives the photosensitive drum 21, the development roller 31, the supply roller 33, the agitation member 34, and the like, but the driving unit is not limited to this. For example, a first driving unit that drives the agitation member 34, and a second driving unit that rotationally drives the development roller 31 may be separately provided. In addition, a common drive source for the photosensitive drum 21 and another rotatable member, such as a common drive source for the photosensitive drum 21 and the agitation member 34, may be provided. The control unit 90 is electrically connected to components of the image forming apparatus 1 (various drive devices M1, various power sources E1, E2, and E3, various sensors, etc.). The control unit 90 controls operations of the components by communicating with the components of the image forming apparatus 1.

The control unit 90 executes an image forming operation by controlling the components of the image forming apparatus 1 based on a signal (e.g., image formation start signal, image signal) input from an external apparatus (not illustrated), such as a personal computer, in accordance with an operation performed by an operator.

### 5. Toner Replenishment Configuration and Toner Replenishment Operation

Next, a configuration related to a toner replenishment operation will be described.

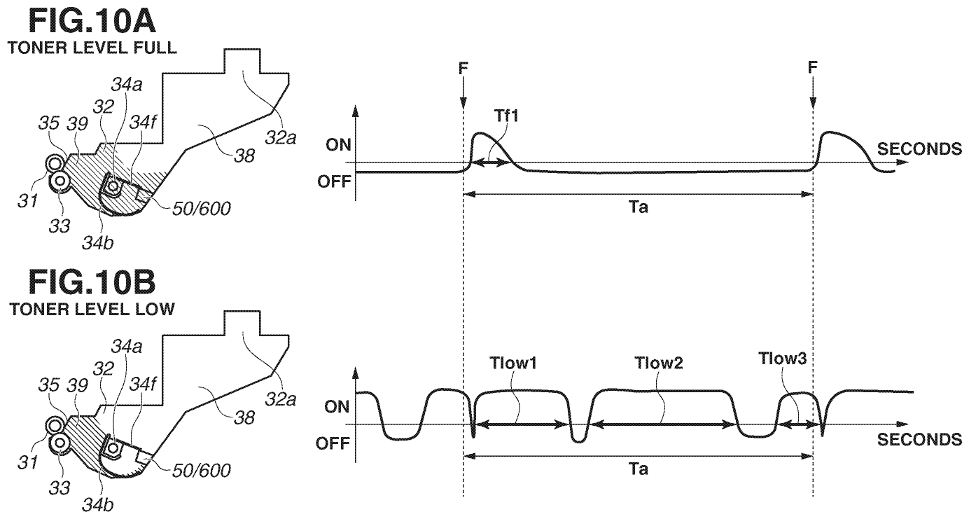

The image forming apparatus 1 according to the present embodiment detects that a toner remaining amount is low when the toner remaining amount has decreased due to image formation on the recording material P, and Y is greater than a second threshold value Tth, which is an index of a predetermined amount. Here, Y denotes an ON time in one cycle time Ta (1.0 second) in FIG. 10 to be described below. That is, when it is detected that the amount of toner in the developer container 32 is smaller than the predetermined threshold value, display for prompting the user to execute toner replenishment is performed on the display unit 301, for example. In the present embodiment, when the user performs toner replenishment, the replenished toner is subjected to toner remaining amount detection, and the toner remaining amount after the replenishment is detected. A toner stop filling operation (e.g., serving as a toner replenishment operation), which is a characteristic of the present embodiment, and a drive operation will be described below in detail. According to embodiments of the present disclosure, the toner stop filling operation and the drive operation may be referred to as a first operation and a second operation, respectively.

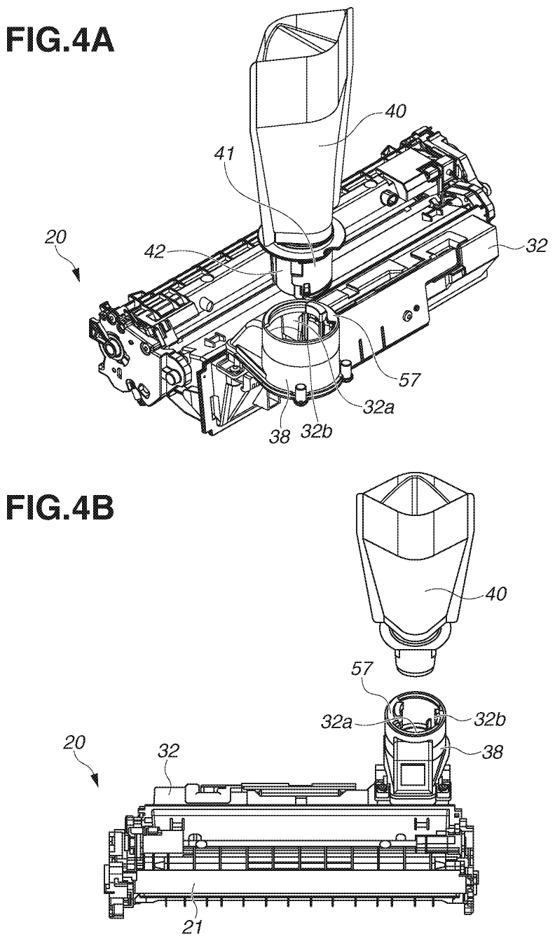

FIG. 3 is a perspective view of the image forming apparatus 1 according to the present embodiment. FIG. 4A is a perspective view illustrating the developer container 32 and toner pack 40 serving as a replenishment container, and FIG. 4B is a front view illustrating the developer container 32 and the toner pack 40. As illustrated in FIGS. 3, 4A, and 4B, the image forming apparatus 1 according to the present embodiment employs an external replenishment method (direct replenishment method) that can replenish toner from the outside of the apparatus to the developer container 32 in the apparatus using the replenishment container 40. That is, in a replenishment operation, an operator supplies toner to the developer container 32 in the apparatus by attaching the toner pack 40 serving as a replenishment container to a replenishment projection portion 57 (attachment portion) that is exposed to the outside of the image forming apparatus 1. In the present embodiment in which the direct replenishment method is employed, as illustrated in FIG. 3, an opening/closing member 83 for replenishing toner from the toner pack 40 (developer replenishment container) is provided on the discharge tray 81 in an openable and closeable manner. In the discharge tray 81, a main body side replenishment opening portion 82 opened upward is formed. The opening/closing member 83 is configured to be movable between a closed position where a replenishment port 32a (developer receiving port) is covered in such a manner that the toner pack 40 cannot be attached to the developer container 32, and an open position where the replenishment port 32a is exposed in such a manner that the toner pack 40 can be attached to the developer container 32. At the closed position, the opening/closing member 83 functions as a part of the discharge tray 81. The opening/closing member 83 and main body side replenishment opening portion 82 are formed on the left side of the discharge tray 81.

The configurations of the developer container 32 and the toner pack 40 will be described with reference to FIGS. 4A and 4B.

As illustrated in FIGS. 4A and 4B, the developer container 32 includes a projection portion 38 projecting upward and toward the apparatus front side from one end portion in the longer side direction. At an upper end portion (leading end portion) of the projection portion 38, the attachment portion 57 to which the toner pack 40 can be attached is provided, and in the attachment portion 57, the replenishment port 32a for replenishing a developer from the toner pack 40 into the developer container 32 is formed. The replenishment port 32a is opened to the outside of the developer container 32, and is communicated with an inlet 32c (storage chamber opening) that is opened on the inner wall of the toner storage chamber 32d of the developer container 32. That is, a toner replenishment path extending from the replenishment port 32a to the inlet 32c is formed inside the projection portion 38, and the replenishment port 32a and the inlet 32c are configured to communicate with each other. That is, in the present embodiment, arranging the attachment portion 57 including the replenishment port 32a on the apparatus front side of the image forming apparatus 1 facilitates the user's toner replenishment operation for the developer container 32.

The toner pack 40 is configured to be attachable to and detachable from the attachment portion 57 provided at the leading end portion of the projection portion 38 of the developer container 32. In addition, the toner pack 40 includes a shutter member 41 that is provided at an opening portion and is openable and closeable, and a plurality of projections 42 formed in such a manner as to correspond to a plurality of groove portions 32b formed in the attachment portion 57. The shutter member 41 is configured to be movable between an open position where the opening portion is opened, and a closed position where the opening portion is closed.

In a case where the user supplies toner to the developer container 32, positioning is performed in such a manner that the projections 42 of the toner pack 40 pass through the groove portions 32b of the attachment portion 57, and the toner pack 40 is coupled to the attachment portion 57. Then, when the toner pack 40 is rotated by 180 degrees in this state, the shutter member 41 of the toner pack 40 abuts against an abutment portion (not illustrated) of the attachment portion 57, thereby rotating relative to the main body of the toner pack 40 and opening the shutter member 41. The toner stored in the toner pack 40 accordingly leaks from the toner pack 40, and the leaked toner enters the developer container 32 via the replenishment port 32a. The shutter member 41 may be provided on the replenishment port 32a side.

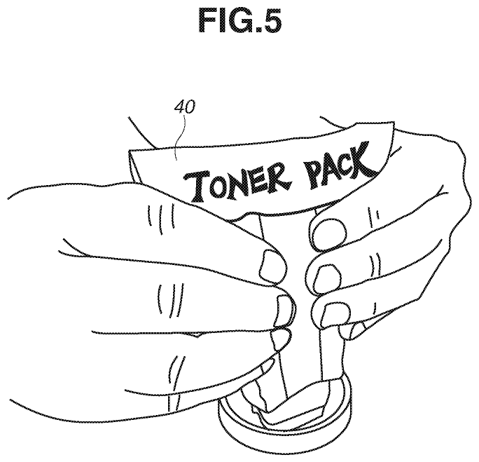

Since the toner stored in the toner pack 40 is a powder, the toner may aggregate inside the toner pack 40. For this reason, as illustrated in FIG. 5, when using the toner pack 40, the user shakes the toner pack 40 well and manually loosens the toner before use.

In the present embodiment, the replenishment container includes an easily deformable plastic bag, but the replenishment container is not limited to this. For example, the replenishment container may include a bottle container having a substantially conical shape or a substantially cylindrical shape. In addition, for example, the replenishment container may include a paper container made of paper. Furthermore, as a method of discharging toner from the replenishment container, the operator may squeeze the replenishment container by hand in a case where the replenishment container is the toner pack 40 as in the present embodiment or a paper container, and it is desirable that the operator discharges the toner while shaking the container such as tapping in a case where the container is a bottle container. In addition, to discharge toner from the replenishment container, a bottle container may be provided with a discharge mechanism. In addition, the discharge mechanism may be configured to engage with a drive mechanism provided on the apparatus main body of the image forming apparatus 1, and receive drive from the drive mechanism.

When the user is executing the replenishment operation, a toner stop filling operation (to be described below), which is a first operation, is executed by the image forming apparatus 1. That is, during the interval from when the user moves the opening/closing member 83 to the open position to when the user moves the opening/closing member 83 to the closed position, the toner stop filling operation that is the first operation is executed.

After the replenishment operation is completed by the user, i.e., after the toner stop filling operation is completed by the image forming apparatus 1, the control unit 90 performs control in such a manner as to execute a drive operation as a second operation. By the control unit 90 performing control in such a manner as to execute a drive operation as a toner replenishment operation, the agitation member 34 in the developer container 32 rotates, and the toner replenished from the replenishment port 32a is fed toward the development roller 31 and the supply roller 33. Although the replenishment port 32a and the projection portion 38 are arranged at one end portion in the longer side direction of the developer container 32, by repeating the rotation of the agitation member 34, the toner spreads over the entire region of the developer container 32. On the other hand, in the toner stop filling operation, the toner is replenished in a state in which the rotation of the agitation member 34 and the development roller 31 is stopped.

A positional relationship between a toner replenishment path of the developer container 32 and the scanner unit 11 will be described with reference to FIG. 6. FIG. 6 is a schematic plan view illustrating a positional relationship between the scanner unit 11, and the replenishment port 32a and the inlet 32c of the developer container 32, and is a plan view along a scanning optical path of the laser light L of the scanner unit 11.

The scanner unit 11 includes a light source 110, an aperture 111, an incident optical element 112, the deflector 113, and an imaging optical element 114. The light source 110 is a semiconductor laser, for example.

The aperture 111 has an elliptical opening portion, and regulates the diameter of the light flux emitted from the light source 110 in a main scanning direction and a sub scanning direction. The incident optical element 112 has positive refractive power in a main scanning cross-section, and converts the light flux having passed through the aperture 111 into a parallel light flux in the main scanning cross-section. The scanner unit 11 reduces refractive power required for the imaging optical element 114, by converting the light flux having passed through the aperture 111 into weakly convergent light flux. In addition, the incident optical element 112 has positive refractive power in a sub scanning cross-section, and forms a linear image elongated in the main scanning direction by converging the light flux having passed through the aperture 111 onto the vicinity of a deflection surface 113a of the deflector 113 in the sub scanning cross-section.

The imaging optical element 114 has positive refractive power in both the main scanning cross-section and the sub scanning cross-section. By converging the light flux deflected by the deflector 113 in both the main scanning cross-section and the sub scanning cross-section, the imaging optical element 114 forms a spot-like image near the scanned surface of the photosensitive drum 21. Specifically, the imaging optical element 114 has two optical surfaces (lens surfaces), i.e., an entrance surface and an exit surface, and is configured such that the light flux deflected by the deflection surface 113a of the deflector 113 scans the scanned surface of the photosensitive drum 21 in the main scanning cross-section with a desired scanning characteristics. In addition, in the sub scanning cross-section, the imaging optical element 114 places the vicinity of the deflection surface 113a of the deflector 113 and the vicinity of the scanned surface of the photosensitive drum 21 into a mutually conjugate relationship. This enables tilt-correction compensation (that is, reduction of scan-position deviation in the sub scanning direction on the scanned surface of the photosensitive drum 21 when the deflection surface 113a becomes tilted).

In this manner, the light flux emitted from the light source 110 passes through the aperture 111 and the incident optical element 112, and then enters the deflection surface 113a of the deflector 113. Then, the light flux reflected and deflected by the deflection surface 113a of the deflector 113 is guided by the imaging optical element 114 to the scanned surface of the photosensitive drum 21. The deflector 113 is rotated at a fixed speed by a drive unit (not illustrated), and optically scans the scanned surface of the photosensitive drum 21 in the main scanning direction indicated by an arrow D, whereby an electrostatic latent image is formed on the scanned surface of the photosensitive drum 21.

As illustrated in FIGS. 6 and 1, the projection portion 38 of the developer container 32 (toner replenishment path from the replenishment port 32a to the inlet 32c) extends above and below the scanning optical path of the laser light L of the scanner unit 11 at a position avoiding the scanning optical path. That is, when viewed in an apparatus left-right direction, the replenishment port 32a is located above the scanning optical path of the laser light L, and the inlet 32c is located below the scanning optical path of the laser light L. The apparatus left-right direction is a direction substantially parallel to the rotational axis directions of the rotatable members, such as the photosensitive drum 21, the development roller 31, the supply roller 33, and the agitation member 34.

In addition, as illustrated in FIG. 6, the toner replenishment path from the replenishment port 32a to the inlet 32c is located at a position included on the inner side of the end portion of the photosensitive drum 21 in the apparatus left-right direction (the center side of the photosensitive drum 21). In addition, in an apparatus front-back direction, the toner replenishment path is located at a position included in a space between the photosensitive drum 21 and the scanner unit 11. That is, the projection portion 38 of the developer container 32 is arranged in such a manner as not to increase an apparatus size in the apparatus left-right direction and the apparatus front-back direction, while avoiding the scanning optical path of the laser light L emitted from the imaging optical element 114.

### 6. Configuration of Toner Remaining Amount Detection Sensor and Detection Method for Toner Remaining Amount

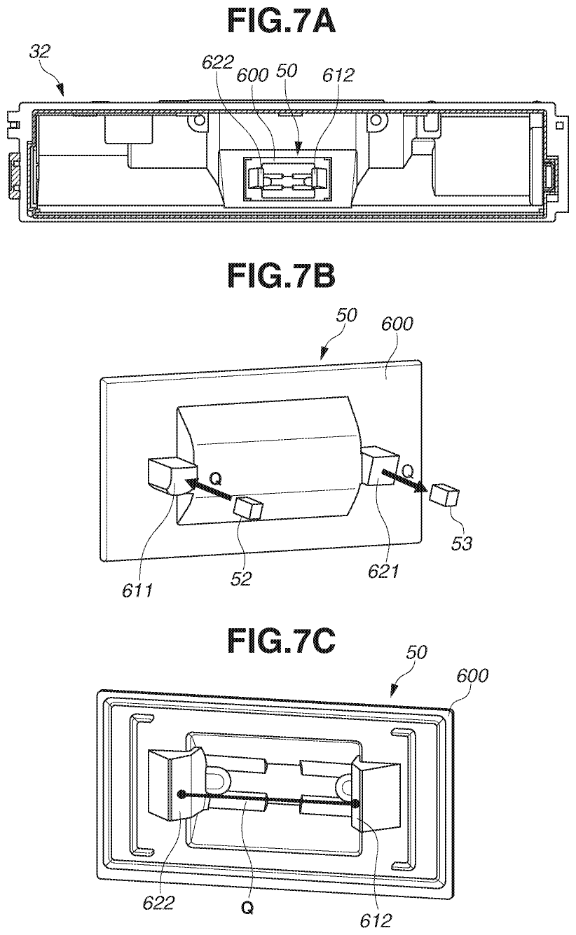

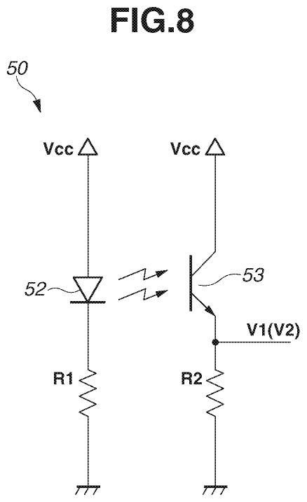

The configuration of the toner remaining amount detection sensor 50 according to the present embodiment, and a detection method for a toner remaining amount will be described with reference to FIGS. 7A to 9. FIGS. 7A to 7C are diagrams illustrating a light guide 600 of the toner remaining amount detection sensor 50. FIG. 7A is a cross-sectional view illustrating a B-B′ surface of the developer container 32 installed in the image forming apparatus 1 illustrated in FIG. 1 that is viewed from the back surface side. FIGS. 7B and 7C are perspective views of the light guide 600. In addition, FIG. 8 is a circuitry diagram illustrating an example of a circuitry configuration of the toner remaining amount detection sensor 50, and FIG. 9 is a block diagram illustrating a control system of the image forming apparatus 1. In the present embodiment, a light transmission type remaining amount detection method is employed for a toner remaining amount detection, but the detection method is not limited to this. The detection method is only required to be a remaining amount detection method that can recognize the change in toner remaining amount over time. For example, a toner remaining amount detection method that is based on residual electrostatic charge detection, or a toner remaining amount detection method of measuring weight may be used.

As illustrated in FIGS. 7A to 7C, in the present embodiment, the light guide 600 included in the toner remaining amount detection sensor 50 is installed at the central part in the rotational axis direction of the development roller 31. The light guide 600 includes a light entrance portion 611 that introduces light from a light emission unit 52 into the light guide 600 on the outside of the developer container 32, and optical path surfaces 612 and 622 that generate an optical path Q on the inside of the developer container 32. Furthermore, the light guide 600 includes a light exit portion 621 for delivering light having passed through the optical path Q in the developer container 32 to a light receiving unit 53. The light guide 600 made of polystyrene having an amorphous structure and high transparency is used.

As illustrated in FIG. 8, the light emission unit 52 uses an LED as a light emission element, and the light receiving unit 53 uses a phototransistor that is turned on by light from the LED, as a light receiving element. A switch (not illustrated) is provided between the light emission unit 52 and a power source voltage Vcc, and by turning the switch on, a voltage from the power source voltage Vcc is applied to the light emission unit 52, and the light emission unit 52 enters a conductive state. On the other hand, a switch (not illustrated) is provided also between the light receiving unit 53 and the power source voltage Vcc, and by turning the switch on, the light receiving unit 53 enters a conductive state by current corresponding to a detected light amount. As the light emission unit 52 and the light receiving unit 53, for example, a halogen lamp or a fluorescent lamp may be applied to the light emission unit 52, and a photodiode or an avalanche photodiode may be applied to the light receiving unit 53.

The power source voltage Vcc and a current-limiting resistor R1 are connected to the light emission unit 52, and the light emission unit 52 emits light by current determined by the current-limiting resistor R1. As illustrated in FIG. 7B, the light emitted from the light emission unit 52 passes through the optical path Q, and is received by the light receiving unit 53. The power source voltage Vcc is connected to a collector terminal of the light receiving unit 53, and a detection resistor R2 is connected to an emitter terminal. The light receiving unit 53 as a phototransistor receives the light emitted from the light emission unit 52, and transmits (outputs) a signal (current) with the intensity corresponding to the amount of the received light. The signal is converted into a voltage V1 by the detection resistor R2, and input to the A/D conversion unit 95 of the control unit 90 (refer to FIG. 9).

The CPU 91 of the control unit 90 determines whether the light receiving unit 53 has received light from the light emission unit 52, based on the level of the input voltage. Based on the length of time during which the light receiving unit 53 detects light when the toner in the developer container 32 is agitated by the agitation member 34 for a fixed time, and the intensity of received light, the CPU 91 of the control unit 90 calculates a toner amount (developer amount) in the developer container 32. That is, the ROM 93 prestores a table that can output a toner remaining amount from a light receiving time and light intensity when toner is conveyed by the agitation member 34, and the control unit 90 predicts/calculates a toner remaining amount based on an input to the A/D conversion unit 95 and the table.

More specifically, a time during which the optical path Q is shielded by the toner conveyed by the agitation member 34 when the agitation member 34 rotates once, i.e., a time during which the light receiving unit 53 does not detect light from the light emission unit 52, changes depending on a toner remaining amount. In addition, the intensity of the light received by the light receiving unit 53 also changes depending on the remaining amount.

That is, when a toner remaining amount is small, a time during which the light receiving unit 53 receives light becomes longer, and the intensity of the light received by the light receiving unit 53 also becomes higher, as compared with when a toner remaining amount is large. The control unit 90 can determine a toner remaining amount level based on such a light receiving time and received light intensity of the light receiving unit 53.

Next, a voltage waveform that is based on a light receiving signal of the light receiving unit 53, and a remaining amount detection method will be described.

The toner remaining amount detection method according to the present embodiment will be described with reference to FIGS. 10A and 10B. FIGS. 10A and 10B are diagrams each illustrating a cross-sectional image of the developer container 32 immediately before the cleaning member 34f passes through the toner remaining amount detection sensor 50, and a waveform of a voltage value obtained by converting the light receiving signal of the light receiving unit 53 by the A/D conversion unit 95. A timing F in the voltage value waveform corresponds to a timing immediately before the cleaning member 34f passes through the toner remaining amount detection sensor 50 in the cross-sectional image diagrams. FIG. 10A illustrates a case where a toner level is FULL, as a case where a toner amount in the developer container 32 is large, and FIG. 10B illustrates a case where a toner level is LOW, as a case where a toner amount in the developer container 32 is small. A shaded area in the cross-sectional image diagram schematically illustrates toner existing in the developer container 32.

In the present embodiment, a maximum value of a voltage value obtained by converting a light receiving signal of the light receiving unit 53 by the A/D conversion unit 95 is 3.3 V, a time during which a voltage of 1 V or more is detected is an ON time, and a time (period) during which a voltage smaller than 1 V is detected is an OFF time (OFF period). Then, a method of determining a toner remaining amount based on an ON time within one cycle time Ta corresponding to one rotation of the agitation member 34 is employed. In the present embodiment, the cycle time Ta for one rotation of the agitation member 34 is 1.0 second. When the ON time in the time Ta is greater, the toner remaining amount is determined to be smaller, and when the ON time is smaller, the toner remaining amount is determined to be larger. In the present embodiment, the toner remaining amount is detected based on the ON time within one cycle time Ta; however, a detection method is not limited to the method. For example, the toner remaining amount may be calculated from the ratio or proportion of the ON time within one cycle time Ta to the OFF time within one cycle time Ta.

The toner level FULL illustrated in FIG. 10A corresponds to a state in which a toner amount is large, and the toner surface is always located in the upper portion of the light guide 600 of the toner remaining amount detection sensor 50. For this reason, only at a timing at which the cleaning member 34f cleans the optical path surfaces 612 and 622 of the light guide 600, the light receiving unit 53 receives light, resulting in an ON time Tf1, but immediately after the cleaning member 34f passes, the state becomes an OFF time. This is because the toner existing near the light guide 600 of the toner remaining amount detection sensor 50 immediately blocks the optical path Q. In the present embodiment, the ON time Tf1 is 0.1 to 0.2 seconds (arrow portion in FIG. 10A), and when the ON time within one cycle time Ta (1.0 second) falls below 0.1 to 0.2 seconds, the toner level is determined to be FULL. When “Tfth” is defined as a threshold value for the toner level FULL, and “Y” as an ON time within one cycle time Ta (1.0 second) as described above, Tfth>Y indicates that the developer container 32 is sufficiently filled with toner. In the present embodiment, the threshold value Tfth is set to 0.2 (s). The threshold value is not limited to Tfth=0.2, and can be arbitrarily set.

In the toner level LOW as illustrated in FIG. 10B, since the toner amount is small, and a time during which the light guide 600 of the toner remaining amount detection sensor 50 is not shielded is longer, the ON time is longer than that in the toner level FULL. In the present embodiment, the ON time at the toner level LOW is a total time of times Tlow1 to Tlow3 indicated by arrows in FIG. 10B, which is 0.6 to 0.7 seconds. On the other hand, the OFF time is formed by a timing at which the cleaning member 34f passes, a timing at which the toner conveyed by the agitation member 34 shields the light guide 600 of the toner remaining amount detection sensor 50, or the like. The phase detection of the agitation member 34 according to the present embodiment is performed by reading these OFF times, and a specific method will be described below in the section of “a voltage waveform that is based on a light receiving signal of the light receiving unit 53, and phase detection of an agitation member”. In the present embodiment, when the ON time within one cycle time Ta (1.0 second) is 0.6 to 0.7 seconds, the toner level is determined to be LOW. When “Tlth” is defined as a threshold value of the toner level LOW, and an ON time in one cycle time Ta (1.0 second) is defined as “Y” as described above, i.e., when Tlth<Y, it means that toner in the developer container 32 has become low. In the present embodiment, the threshold value Tlth is set to 0.7 (s). The threshold value is not limited to Tlth=0.7, and can be arbitrarily set, as long as Tfth≤Tlth.

In the present embodiment, although two toner levels, FULL and LOW, are provided as toner levels, only one level, LOW, may be provided, or a plurality of levels may be additionally provided. Specifically, a toner level MID and a toner level OUT may be additionally provided.

### 7. Toner Replenishment Operation According to Present Embodiment

Next, a toner stop filling operation, which is a toner replenishment operation performed by stopping the rotation of the agitation member 34 will be described. According to the present embodiment the toner stop filling operation serves as a first operation.

In an image forming apparatus in which toner is not filled in the developer container 32, such as when the image forming apparatus 1 is new, the toner stop filling operation is executed. In this manner, an operation in which a toner replenishment operation is executed with the rotation of the agitation member 34 stopped is defined as a toner stop filling operation. The toner stop filling operation is an example of the above-described replenishment operation, and may be included as a part of the replenishment operation. Similarly to the replenishment operation, the toner stop filling operation includes a user's operation of kneading the toner pack 40 as illustrated in FIG. 5, then connecting the toner pack 40 to the replenishment port 32a, and filling the toner in the toner pack 40 into the developer container 32 via the replenishment port 32a. In a drive operation as a second operation to be executed after the toner stop filling operation, the rotation of the agitation member 34, the development roller 31, and the supply roller 33 is started immediately after replenishment, and the replenished toner spreads over the entire region of the developer container 32. On the other hand, in the toner stop filling operation, after the toner remaining amount detection sensor 50 detects the toner stop filling in a drive-stopped state, rotational driving of the agitation member 34, the development roller 31, and the supply roller 33 is started. Starting the drive only after the detection of the toner stop filling operation prevents the development roller 31, the development blade 35, and the supply roller 33 from being damaged due to the development blade 35 and the supply roller 33 rubbing against the development roller 31 when no toner is present.

Hereinafter, a detection method for the toner stop filling operation and operations to be performed before and after the detection will be described.

In the present embodiment, the control unit 90 performs control in such a manner as to perform toner stop filling detection at the time of the toner stop filling operation executed using the toner remaining amount detection sensor 50.

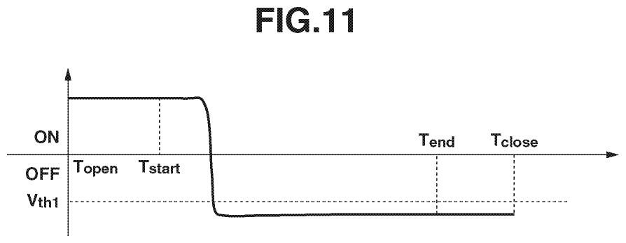

As described so far, the toner remaining amount detection sensor 50 is a sensor that detects the remaining amount of toner in the developer container 32 with reference to a varying output value while performing agitation of toner in the developer container 32 by the agitation member 34. By performing the following detection procedure, it is possible to perform toner stop filling detection without driving the agitation member 34. Hereinafter, a detection operation will be described with reference to FIG. 11.

### (1) Toner Stop Filling Executable Period Topen to Tclose

Before performing the toner stop filling operation, the user moves the opening/closing member 83 to the open position. After that, the toner pack 40 is inserted into the replenishment port 32a, and the toner stop filling operation is started. After the toner stop filling operation ends, the user removes the toner pack 40 from the replenishment port 32a, and moves the opening/closing member 83 to the closed position. As illustrated in FIG. 11, a time at which the opening/closing member 83 is moved to the open position is defined as “Topen”, and a time at which the opening/closing member 83 is moved to the closed position is defined as “Tclose”. The time from the time Topen to the time Tclose is a period during which the toner stop filling operation can be performed, and this period is defined as a toner stop filling executable period. By detecting the time “Topen” and the time “Tclose” as a trigger of each control, the control unit 90 can execute control. The detection of the time “Topen” and the time “Tclose” is implemented by a switch or the like, for example, that is energized in conjunction with the opening/closing of the opening/closing member 83, and transmits a signal to the control unit 90. That is, the control unit 90 detects information indicating that the opening/closing member 83 is located at the open position, and then detects information indicating that the opening/closing member 83 is located at the closed position.

### (2) Monitoring of Toner Remaining Amount Detection Sensor Output Value in Toner Stop Filling Executable Period

During the toner stop filling executable period from the time Topen to the time Tclose, the control unit 90 brings the toner remaining amount detection sensor 50 into an active state, monitors an output value, and detects information regarding the presence or absence of the toner stop filling operation. Specifically, by detecting information regarding toner by the toner remaining amount detection sensor 50, whether the toner stop filling operation is normally executed is monitored.

FIG. 11 illustrates an example of a waveform of a voltage value V(t) (first value) obtained by converting a light receiving signal of the light receiving unit 53 by the A/D conversion unit 95 at the time of the toner stop filling operation. A time Tstart is a time at which the toner stop filling operation is actually started, and a time Tend is a time at which the toner stop filling operation is actually ended. In acquiring the waveform illustrated in FIG. 11, in this experiment, during a period from the time Tstart to the time Tend, a flow rate of toner flowing from the toner pack 40 into the developer container 32 is kept constant. The start and end times (Tstart and Tend) of the toner stop filling operation are not detected by the image forming apparatus 1. These are illustrated in FIG. 11 only for the explanation of a voltage waveform. In the present embodiment, a configuration in which the image forming apparatus 1 does not detect the start and end times (Tstart and Tend) of the toner stop filling operation is employed, but the configuration is not limited to this configuration. For example, the control unit 90 arranged in the image forming apparatus 1 may detect the start and the end of the toner stop filling operation using a detection unit.

The toner filled into the developer container 32 shields the optical path when reaching the vicinity of the toner remaining amount detection sensor 50 serving as an optical detection sensor unit. Accordingly, a light amount detected by the toner remaining amount detection sensor 50 decreases. When a sensor output value Vend at the time point Tclose (first value at the time Tclose) is lower than a first threshold value Vth1, it is detected that toner has been sufficiently filled by the toner stop filling operation. In the present embodiment, Vth1=1 V is set. In this manner, the detection of the toner stop filling operation can be performed without the driving of the agitation member 34. Here, detecting the toner stop filling operation also includes control of detecting whether the toner stop filling operation has been actually executed. In addition, detecting the toner stop filling operation also includes controlling whether to transition to the next replenishment operation, i.e., whether to rotate the agitation member 34, when the output value Vend crosses the threshold value Vth1, without directly determining that the execution or non-execution of the toner stop filling operation has been detected. In addition, instead of a method of referring to the sensor output value Vend at the time point Tclose, in a case where the output value Vend crosses the first threshold value Vth1 a plurality of times, or in a case where the output value Vend remains below the first threshold value Vth1 for a certain time length, it may be determined that the toner stop filling operation has been detected. Alternatively, in a case where a difference between an output value V and an output value Von at the time of ON exceeds a threshold value, it may be determined that the toner stop filling operation has been detected. That is, it is important that a sensor output value V changes and crosses the threshold value Vth in determining that the toner stop filling operation has been detected.

In addition, in the present embodiment, it is desirable to execute the toner stop filling operation when the image forming apparatus 1, therefore, the developer container 32, is new. If toner is stored in the developer container 32, the execution of the toner stop filling operation may be omitted. That is, in the toner replenishment operation executed in a state other than a new state, some toner exists near the agitation member 34 and the development roller 31, and therefore a replenishment operation may be executed while driving the agitation member 34 and the development roller 31.

In the present embodiment, a case where an output value of the toner remaining amount detection sensor 50 is output as a voltage has been described; however, a physical amount to be output is not limited to a voltage. For example, the above-described values Vend and Vth1 may be more generally expressed as values Send and Sth1 as detection signals.

### (3) Phase of Agitation Member

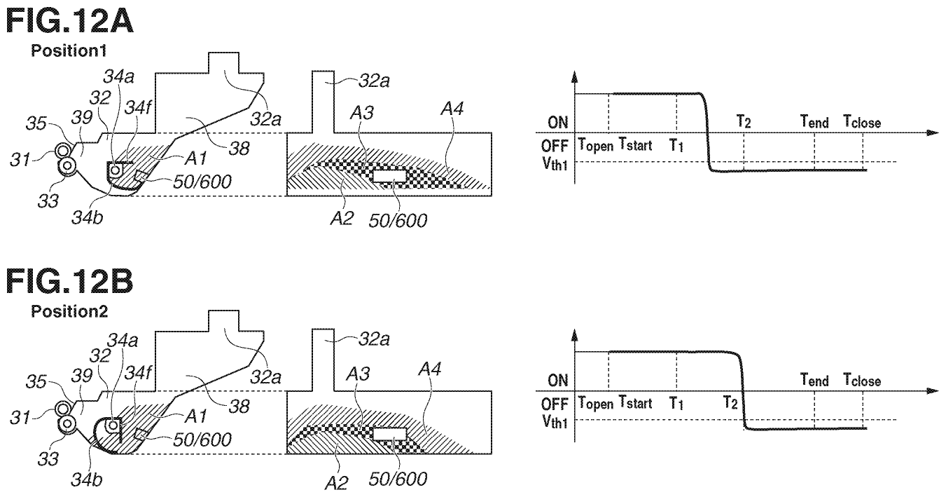

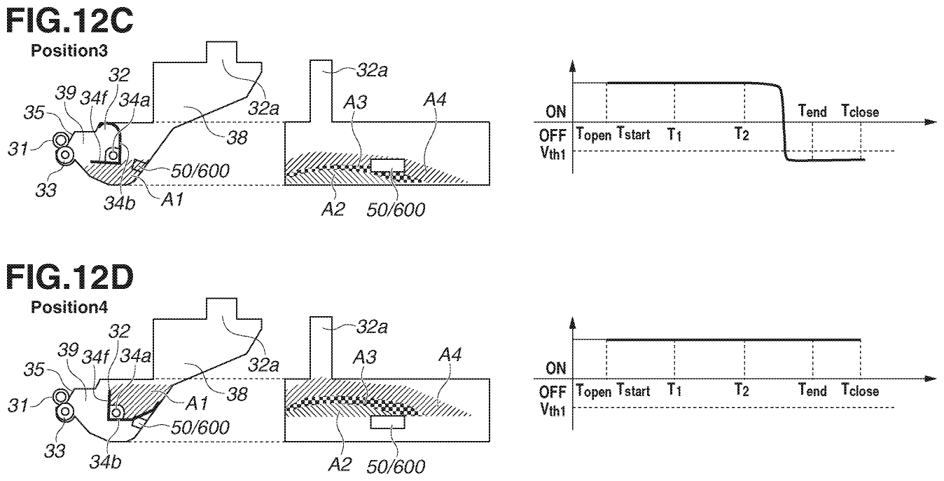

FIGS. 12A to 12D are diagrams illustrating cross-sectional views of the developer container 32 that are obtainable when the toner stop filling operation is performed on the developer containers 32 in which the phases of the agitation member 34 are different, and toner remaining amount detection results. Specifically, FIGS. 12A to 12D are cross-sectional image diagrams in a surface that is vertical to the left-right direction of the developer container 32 including the toner remaining amount detection sensor 50, transmissive image diagrams illustrating the developer container 32 viewed from the front side, and diagrams each illustrating a voltage waveform obtained by converting a light receiving signal of the light receiving unit 53 at the time of stop filling by the A/D conversion unit 95.

In each toner stop filling operation, during a period from the time Tstart to the time Tend, a flow rate of toner flowing from the toner pack 40 into the developer container 32 is kept constant.

In addition, the period from the time Tstart to the time Tend is equally divided into three, the times at which the periods switch are defined as T1 and T2 as illustrated in FIG. 12.

In the cross-sectional image diagram, toner at the time Tclose is illustrated as a right-upward hatching pattern (A1). In the transmissive image diagram, the toner filled during a period from the time Tstart to the time T1 is illustrated by a left-upward hatching pattern (A2), the toner filled during a period from the time T1 to the time T2 is illustrated by a checkered pattern (A3), and the toner filled during a period from the time T2 to the time Tend is illustrated by a right-upward hatching pattern (A4).

The phases of the agitation member 34 illustrated in the cross-sectional image diagrams in FIGS. 12A to 12D are defined as Position1 to Position4, respectively.

The Position1 is a phase where the free end 34be1 of the blade portion 34b of the agitation member 34 exists immediately below the toner remaining amount detection sensor 50. When the phase of the agitation member 34 is the Position1, the toner to be filled is accumulated in the developer container 32 as follows. First of all, during the period from the time Tstart to the time T1, as illustrated in FIG. 12A, the toner is blocked by the blade portion 34b of the agitation member 34 and accumulated in a region immediately below the replenishment port 32a that is illustrated by the left-upward hatching pattern (A2) in the transmissive image diagram. At this stage, toner does not exist near the toner remaining amount detection sensor 50, and as seen from the diagram illustrating a voltage waveform, light continues to be transmitted near the toner remaining amount detection sensor 50. Thus, the toner remaining amount detection sensor 50 continues to detect light. Next, the toner to be filled from the time T1 to the time T2 is blocked by the blade portion 34b of the agitation member 34 and accumulated in a region illustrated by the checkered pattern (A3) in the transmissive image diagram. The checkered pattern (A3) in the transmissive image diagram overlaps the toner remaining amount detection sensor 50, and it can be seen that toner has been filled up to the position of the toner remaining amount detection sensor 50 during the period from the time T1 to the time T2. From the diagram illustrating a voltage waveform in FIG. 12A, it also can be seen that the amount of light detected by the toner remaining amount detection sensor 50 has decreased and the output falls below the first threshold value Vth1 during the period from the time T1 to the time T2. Lastly, the toner filled during the period from the time T2 to the time Tend is accumulated in a region illustrated by the right-upward hatching pattern (A4) in the transmissive image diagram. At this time, the toner remaining amount detection sensor 50 is buried in the toner, and its output value remains unchanged during the period from the time T2 to the time Tend. As seen from the diagram illustrating a voltage waveform, at the time Tclose, the sensor output value falls below the first threshold value Vth1, and the control unit 90 detects that the toner stop filling operation has been performed, i.e., toner has been sufficiently replenished into the developer container 32.

The Position2, the Position3, and the Position4 are phases of the agitation member 34 that are advanced clockwise by 90°, 180°, and 270°, respectively, relative to the Position1.

When the agitation member 34 is at the phase of the Position2, similarly to the Position1, the filled toner is blocked by the blade portion 34b of the agitation member 34 and accumulated in the developer container 32. Nevertheless, a toner amount required for toner to be filled up to the position of the toner remaining amount detection sensor 50 when the phase is the Position2 is larger than that when the phase is the Position1. For this reason, even if the toner stop filling operation is performed, similarly to the Position1, it takes time for the output value of the toner remaining amount detection sensor 50 to fall below the first threshold value Vth1. As seen from the transmissive image diagram and the diagram illustrating a voltage waveform that are illustrated in FIG. 12B, at a time after the time T2, which is later than that in the case of the Position1, the toner remaining amount detection sensor 50 is blocked by the filled toner.

When the agitation member 34 is at the phase of the Position3, as illustrated in FIG. 12C, the filled toner is accumulated in the developer container 32 without being blocked by the agitation member 34. Then, if the toner has been filled up to the position of the toner remaining amount detection sensor 50, the amount of light detected by the toner remaining amount detection sensor 50 decreases, and the output falls below the first threshold value Vth1. A toner amount required for toner to be filled up to the position of the toner remaining amount detection sensor 50 is even larger than that when the phase is the Position2. Accordingly, at a time between the time T2 and the time Tend, which is later than that in the case of the Position2, the toner remaining amount detection sensor 50 is blocked by the filled toner.

When the agitation member 34 is at the phase of the Position4, as illustrated in the cross-sectional image diagram illustrated in FIG. 12D, the filled toner is prevented by the agitation member 34 from reaching the position of the toner remaining amount detection sensor 50. For this reason, since the output value of the toner remaining amount detection sensor 50 does not fall below the first threshold value Vth1 even at the time point Tclose, the control unit 90 cannot detect information regarding the toner stop filling operation.

As described above, the minimum toner filling amount required for the detection of information regarding the toner stop filling operation increases in the order of the phases Position1, Position2, and Position3 of the agitation member 34. On the other hand, an agitation phase like the phase of the Position4 where information regarding the toner stop filling operation cannot be detected also exists.

That is, by appropriately setting the phase of the agitation member 34 at the time of toner remaining amount detection, it is possible to desirably set the minimum toner filling amount required for the detection of information regarding the toner stop filling operation. The minimum toner filling amount required for the detection of information regarding the toner stop filling operation is only required to be a toner amount that can sufficiently avoid damage caused by the development blade 35 and the supply roller 33 rubbing against the development roller 31 during driving. That is, a larger amount may be set depending on the configuration of the image forming apparatus 1 and various conditions. In the present embodiment, by performing the detection of information regarding the toner stop filling operation at the agitation phase of the Position1, it is possible to effectively avoid damage to various members caused by rubbing. In addition, by setting the agitation phase of the Position2 or the Position3, the minimum toner filling amount suitable for detecting information regarding the toner stop filling operation increases as compared with the Position1. Nevertheless, by appropriately setting the amount, the toner stop filling operation can be executed at any of these positions. This also applies to Position4, and the minimum toner filling amount can be set in accordance with the Position4.

In this manner, the minimum toner filling amount can be set in accordance with an agitation phase. For example, it is possible to set the minimum toner filling amount that allows detection of a sufficient toner amount to prevent various image defects in image formation. In addition, it is also possible to set the minimum toner filling amount that allows detection of a toner amount expected in a case where all toner in the pack is consumed in the toner stop filling operation, using the intended toner pack 40. That is, it can be said that the Position1 is effectively used in a case where the volume of the developer container 32 is relatively small, the Position3 and Position4 are effectively used in a case where the volume of the developer container 32 is relatively large. Accordingly, the setting of the minimum toner filling amount that is based on the setting of these agitation phases may be desirably changed depending on the configuration of an apparatus to which the present disclosure is applied, and various conditions. In addition, the design may be made assuming a case where the most difficult configuration for detecting toner may occur, irrespective of the volume of the developer container 32 and the agitation phase.

Heretofore, the description has been given of a case where the flow rate of toner flowing from the toner pack 40 into the developer container 32 is kept constant from the time Tstart to the time Tend, and the toner stop filling operation is performed.

Nevertheless, in implementing the above-described detection of information regarding the toner stop filling operation, the above-described flow rate at the time of toner stop filling operation need not be constant. For example, in an irregular flow rate change caused by a manual operation of the user, a time at which toner reaches the toner remaining amount detection sensor 50, and blocks the toner remaining amount detection sensor 50 becomes indeterminate. Nevertheless, since the minimum required toner filling amount remains unchanged, it is possible to perform the detection of information regarding the toner stop filling operation based on the toner remaining amount detection.

In addition, the setting of the phase of the agitation member 34 is implemented by setting the phase when the agitation member 34 is assembled during assembly of the image forming apparatus 1, for example.

Next, toner remaining amount detection serving as second detection that is executed after the detection of information regarding the toner stop filling operation serving as first detection will be described.

In the present embodiment, after information regarding the toner stop filling operation is detected, a drive operation serving as a second operation, which includes the rotation of the agitation member 34, the development roller 31, and the supply roller 33, is started. The toner stop filling operation and the drive operation may be collectively defined as a toner replenishment operation, or each may be defined as a toner replenishment operation. In this drive operation, toner remaining amount detection is performed using the toner remaining amount detection sensor 50. As described above, the toner remaining amount detection is controlled and executed by the control unit 90 based on an ON time within one cycle time Ta during which the agitation member 34 rotates once, in accordance with the method illustrated in FIGS. 10A and 10B.

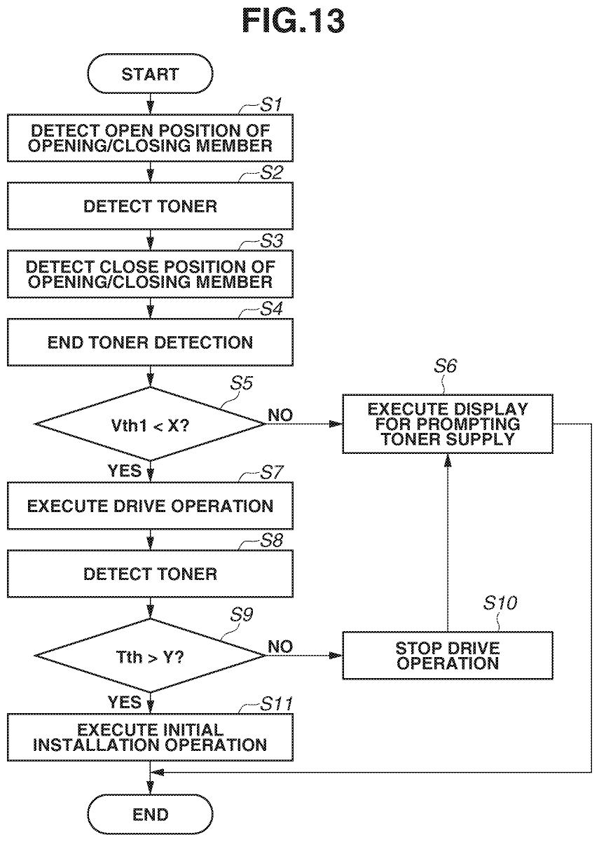

Based on a flowchart in FIG. 13 that illustrates operations to be performed before and after the toner stop filling operation, a series of operations to be performed before and after the toner stop filling operation will be described.

First of all, in step S1, by the user moving the opening/closing member 83 to the open position, the control unit 90 detects information indicating that the opening/closing member 83 has moved to the open position. In step S1, the control unit 90 detects the information indicating that the opening/closing member 83 has moved to the open position, at the time Topen. Accordingly, in subsequent step S2, the control unit 90 starts the detection of toner information regarding the toner stop filling operation, at the time Topen. While the detection of toner information regarding the toner stop filling operation is performed, the user attaches the toner pack 40 to the replenishment port 32a and supplies toner from the toner pack 40 toward the developer container 32. If the user determines that toner has been sufficiently replenished from the toner pack 40 to the developer container 32, the user detaches the toner pack 40 from the replenishment port 32a, and moves the opening/closing member 83 to the closed position. In step S3 in which the user moves the opening/closing member 83 to the closed position, the control unit 90 detects the closed position of the opening/closing member 83 at the time Tclose, and in step S4, the control unit 90 performs control in such a manner as to end the detection of toner information regarding the toner stop filling operation.

In step S5, the control unit 90 determines whether toner information regarding the toner stop filling operation has been detected. When an output value Vend detected by the toner remaining amount detection sensor 50 at the time point Tclose is lower than the threshold value Vth1 (YES in step S5), toner filling has been sufficiently performed by the toner stop filling operation, and accordingly the control unit 90 performs control in such a manner as to execute a subsequent drive operation. That is, based on information regarding toner serving as a developer, in the toner stop filling operation serving as a toner replenishment operation, the control unit 90 controls the drive motor M1 of the agitation member 34, which serves as a first driving unit, and the drive motor M1 of the development roller 31, which serves as a second driving unit. In the present embodiment, the drive motor M1 serves both as the first driving unit and the second driving unit. Here, in step S5, it can also be said that the control unit 90 determines whether the toner stop filling operation has been executed. When Vend=X, in a case where it is determined in step S5 that Vth1<X is satisfied (YES in step S5), the processing proceeds to step S7. In step S7, the control unit 90 performs control in such a manner as to start a drive operation including the rotation of the agitation member 34, the development roller 31, and the supply roller 33. On the other hand, in a case where it is determined in step S5 that Vth1<X is not satisfied (NO in step S5), the processing proceeds to step S6. In step S6, the control unit 90 performs display for showing insufficient toner remaining amount or prompting toner replenishment, on the display unit 301. The display prompting toner replenishment is a message indicating that the toner remaining amount is insufficient, such as a message “Printing is inexecutable because the toner remaining amount is low. Replenish toner.”. After starting the drive operation in step S7, in step S8, the control unit 90 performs control in such a manner as to execute toner remaining amount detection using the toner remaining amount detection sensor 50. Here, an ON time in one cycle time Ta (1.0 second) is defined as “Y”. In a case where information indicating that toner exists by an amount exceeding a threshold value Tth as a second threshold value is detected by the toner remaining amount detection sensor 50 (Tth>Y) (YES in step S9), the processing proceeds to step S11. In step S11, the control unit 90 performs control in such a manner as to perform an initial installation operation. The initial installation operation, which is a preparation operation for an image forming operation of forming an image on the recording material P, is an operation in which the drive motor M1 is activated and warming of a plurality of process devices that involves rotational driving of the photosensitive drum 21 is performed. In step S11, after executing the initial installation operation, the control unit 90 performs control in such a manner as to stop various operations.

Here, the second threshold value Tth may be a value corresponding to a toner amount sufficient to prevent various image defects in the image forming operation, for example. Alternatively, the second threshold value Tth may be a value corresponding to a toner amount expected in a case where the toner stop filling operation is performed using the intended toner pack 40. Here, the second threshold value Tth may be determined using a determination method different from that in toner remaining amount detection in which an output value is compared to the first threshold value Vth1. Specifically, as described above, the second threshold value Tth is determined based on the ON time in one cycle time Ta (1.0 second). In the present embodiment, the second threshold value Tth is set to 0.7 (s). This is the same value as the threshold value Tlth. If the toner amount filled is approximately equivalent to the toner level LOW, it can be determined that, even if the drive operation is executed, damage to members are not caused and image defects are not generated. Here, Tlth=Tth need not necessarily be set.

On the other hand, in a case where it is determined in step S9 that Tth>Y is not satisfied (NO in step S9), the processing proceeds to step S10. In step S10, the control unit 90 performs control in such a manner as to stop the drive operation based on a toner remaining amount detection result obtained by the toner remaining amount detection sensor 50. Then, in step S6, as described above, by the display on the display unit 301, the user is notified of insufficient toner remaining amount and prompted to execute toner replenishment. That is, the control unit 90 performs control in such a manner as to perform display for prompting the user to execute the toner stop filling operation. This can further reduce the possibility of damage to rotatable members, such as the development roller 31, the development blade 35, and the supply roller 33, that may be caused by the drive operation.

An image forming apparatus according to the present embodiment has the following characteristics.

The image forming apparatus includes the photosensitive drum 21 serving as an image bearing member, and the development roller 31 serving as a rotatable developer bearing member that supplies a developer to the photosensitive drum 21. The image forming apparatus includes the developer container 32 serving as a developer storage unit in which the development roller 31 is arranged and toner serving as a developer is stored, the rotatable agitation member 34 that is arranged in the developer container 32 and agitates toner, the development roller 31, and the drive motor M1 that rotationally drives the agitation member 34. The image forming apparatus includes the toner remaining amount detection sensor 50 that is arranged in the developer container 32, and serves as a developer detection unit that detects information regarding toner stored in the developer container 32. The image forming apparatus includes the attachment portion 57 provided with the replenishment port 32a communicating with the developer container 32, to which the toner pack 40 serving as a replenishment container is detachably attachable, and the control unit 90 that controls the drive motor M1. Toner is replenished to the developer container 32 through the replenishment port 32a from the toner pack 40 attached to the attachment portion 57, and a replenishment operation is executed in a state in which rotation of the development roller 31 and the agitation member 34 is stopped, without performing a rotational operation of the development roller 31 and the agitation member 34. Then, the control unit 90 controls the drive motor M1 based on information regarding toner in the toner stop filling operation serving as a replenishment operation.

In addition, the drive motor M1 may be a common drive source that rotates both the agitation member 34 and the development roller 31. In this case, the development roller 31 is configured to rotate by rotating the agitation member 34.

The image forming apparatus includes the opening/closing member 83 movable to the open position where the replenishment port 32a is exposed and a developer can be replenished from the replenishment container to the developer storage unit, and to the closed position where the replenishment port 32a is shielded and a developer cannot be replenished from the replenishment container to the developer storage unit. During a period from when information indicating the opening/closing member 83 is located at the open position is detected to when information indicating the opening/closing member 83 is located at the closed position is detected, the control unit 90 performs control in such a manner as to execute the detection of information regarding a developer in a replenishment operation using the toner remaining amount detection sensor 50. When the information indicating the opening/closing member 83 is located at the closed position is detected, the control unit 90 performs control in such a manner as to end executing the control by the toner remaining amount detection sensor 50. When the information indicating the opening/closing member 83 is located at the open position is detected, the control unit 90 performs control in such a manner as to start to execute the control by the toner remaining amount detection sensor 50. Based on information regarding a developer in a replenishment operation that has been detected when the information indicating the opening/closing member 83 is located at the closed position is detected, the control unit 90 controls the drive motor M1. The information regarding a developer in the toner stop filling operation serving as a toner replenishment operation refers to a first value V that is information regarding the amount of toner stored in the developer container 32. The image forming apparatus includes the ROM 93 serving as a storage unit that stores a first threshold value for the first value. In a case where the first value crosses the first threshold value Vth1, the control unit 90 performs control in such a manner as to execute a drive operation as a second operation of rotating the agitation member 34, after the toner stop filling operation as a first operation. The image forming apparatus includes the display unit 301 that displays information regarding the toner filled in the developer container 32, and in a case where the first value does not cross the first threshold value, the control unit 90 performs control in such a manner as to display information indicating that a developer has not been replenished into the developer container 32, on the display unit 301. Alternatively, the control unit 90 performs control in such a manner as to display information for prompting the user to replenish toner from the toner pack 40 to the developer container 32. The ROM 93 stores the second threshold value Tth that is a threshold value different from the first threshold value. In a case where the first value crosses the second threshold value in the drive operation, the control unit 90 performs control in such a manner as to execute an initial installation operation serving as a preparation operation to be executed before an image forming operation of forming an image on the recording material P, after the drive operation. In a case where the first value does not cross the second threshold value, the control unit 90 performs control in such a manner as to display information indicating that toner has not been replenished into the developer container 32, on the display unit 301. Alternatively, the control unit 90 performs control in such a manner as to display information for prompting the user to replenish toner from the toner pack 40 to the developer container 32.

The toner remaining amount detection sensor 50 includes the light entrance portion 611 through which light emitted by the image forming apparatus 1 enters, and the light exit portion 621 that lets through light toward a light receiving unit provided in the image forming apparatus. The toner remaining amount detection sensor 50 can detect an output voltage that is a first value corresponding to light received by the light receiving unit.

As described above, in the present embodiment, by detecting toner information regarding the toner stop filling operation, toner can be detected in a state in which the driving of the development roller 31 and the agitation member 34 is stopped. Then, after the toner stop filling operation is executed, it is possible to suitably determine that toner exists in the developer container 32 when starting the driving of the development roller 31, the agitation member 34, and the like.

Another embodiment of the present disclosure will be described. Basic configurations and operations of an image forming apparatus according to the present embodiment are the same as those of the image forming apparatus according to the first embodiment. Accordingly, in the image forming apparatus according to the present embodiment, components having functions or configurations that are the same as or corresponding to those of the image forming apparatus according to the first embodiment are assigned the same reference numerals as those of the image forming apparatus according to the first embodiment, and the detailed description will be omitted.

In stop filling detection to be executed at the time of the toner stop filling operation in the first embodiment, for example, a relatively large amount of air may be contained in the toner pack 40 before toner filling. In this case, the amount of toner near the toner remaining amount detection sensor 50 may be small at the time Tclose. In such a case, by the toner stop filling detection method that refers to a sensor output value at the time point Tclose that has been described in the first embodiment, even though toner stop filling has been performed, the execution of the toner stop filling may fail to be detected. In view of the foregoing, the present embodiment is directed to providing a method that can perform toner stop filling detection even in the above-described situation.

### 1. Toner Stop Filling Determination Method

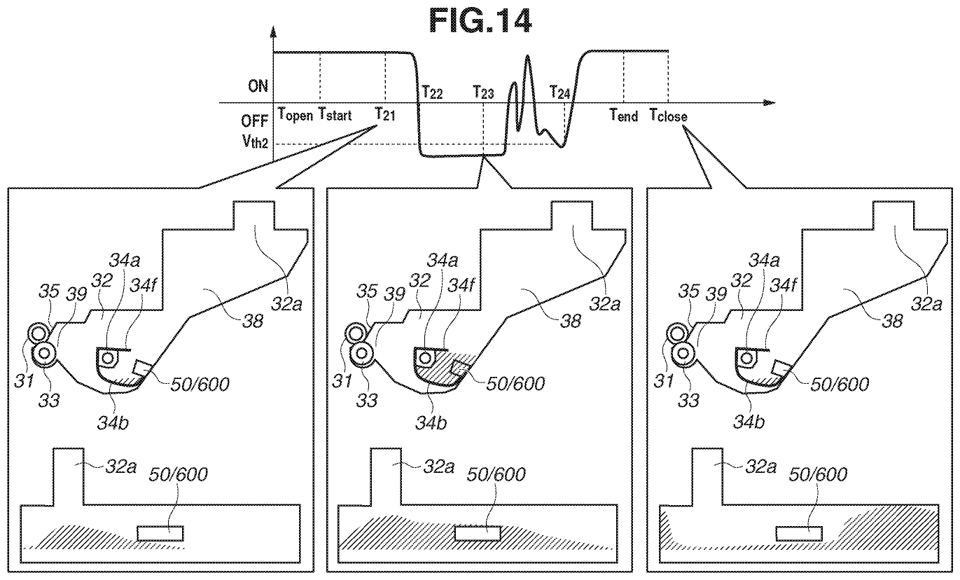

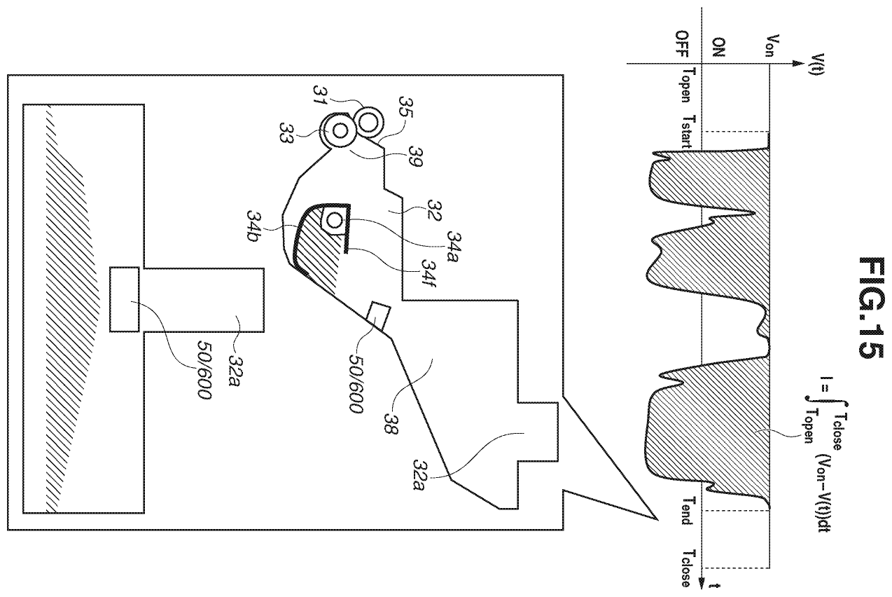

An upper part of FIG. 14 illustrates an example of a voltage waveform obtained by converting a light receiving signal of the light receiving unit 53 by the A/D conversion unit 95 when the toner stop filling operation is performed.

A lower part of FIG. 14 illustrates cross-sectional image diagrams in a surface that is vertical to the left-right direction of the developer container 32 including the toner remaining amount detection sensor 50 at timings T21, T23, and Tclose, and transmissive image diagrams illustrating the developer container 32 viewed from the front side.

In a test implementation of FIG. 14, the toner stop filling operation was performed during a period from the time Tstart to the time Tend. During a period from a time Tstart to a time T23, the toner stop filling operation was executed in such a manner that toner mainly flows into the developer container 32, and after that, during a period from the time T23 to the time Tend, the toner stop filling operation was executed in such a manner that fluid obtained by actively mixing toner and air flows into the developer container 32. The phase of the agitation member 34 was set to the phase corresponding to the Position1 described in the first embodiment.

First of all, the toner stop filling operation starts from the time point Tstart, and toner is blocked by the blade portion 34b of the agitation member 34 and accumulated in a region immediately below the replenishment port 32a. At a time point T21, toner hardly exists in a detection region of the toner remaining amount detection sensor 50. As seen from FIG. 14 illustrating a voltage waveform, in the toner remaining amount detection sensor 50, light continues to be transmitted, and the output voltage remains unchanged from that of before the start of the toner stop filling operation. At the time T22, toner filling further progresses, and the toner that is filled reaches up to the position of the toner remaining amount detection sensor 50. Accordingly, the amount of light detected by the toner remaining amount detection sensor 50 decreases, and the output voltage falls below a threshold value Vth2.

During a period from the time Tstart to the time T23, only toner is filled, and the filled toner starts to be accumulated immediately below the replenishment port 32a. Then, while being blocked by the blade portion 34b of the agitation member 34, the toner spreads toward the right side of the developer container 32 in the transmissive image diagram in FIG. 14 that is viewed from the front side. At the time point T23, as seen from the cross-sectional image diagram and the transmissive image diagram, the toner added to the developer container 32 covers the toner remaining amount detection sensor 50. Therefore, the output voltage falls below the threshold value Vth2. Up to this time point, the behavior proceeds in the similar manner to that in the first embodiment.

On the other hand, during the period from the time T23 to the time Tend, fluid obtained by mixing toner and air was added into the developer container 32 via the replenishment port 32a. Because air is mixed with the toner, in the developer container 32, the toner scatters in the developer container 32 without being stationarily settled. In the detection region of the toner remaining amount detection sensor 50, the toner scatters across the optical path of the toner remaining amount detection sensor 50, the detected light repeatedly has periods during which it passes through and periods during which it does not pass through. Accordingly, during the period from the time T23 to the time Tend, the voltage waveform repeatedly fluctuates, and after a time T24, the output voltage detected by the toner remaining amount detection sensor 50 becomes an output value exceeding the threshold value Vth2.

Referring to the cross-sectional image diagram and the transmissive image diagram at the time point Tclose, it can be seen that, although sufficient toner has been added to the developer container 32, toner hardly exists in the detection region of the toner remaining amount detection sensor 50. In this manner, at the time Tclose, sufficient toner does not exist in the detection region of the toner remaining amount detection sensor 50, the determination method according to the first embodiment may result in a false detection by the control unit 90 that the toner stop filling operation has not been executed.

In view of the foregoing, in the present embodiment, when the output value detected by the toner remaining amount detection sensor 50 falls below the threshold value Vth2 even once, the toner stop filling operation is regarded as having been performed. In the present embodiment, for example, in a case where the voltage waveform illustrated in FIG. 14 is detected, the toner remaining amount detection sensor 50 is determined to have detected information regarding the toner stop filling operation because the output value falls below the threshold value Vth2 at the time T22 as a result of the toner stop filling operation.

In the present embodiment, the description has been given of a case where the output value of the toner remaining amount detection sensor 50 is output as a voltage, but a physical amount to be output is not limited to a voltage. The above-described values V(t) and Vth2 may be more generally expressed as S(t) and Sth2 as signals. In addition, in the description of the above-described embodiment, the voltage value V(t) is described to be continuous, but the actual values acquired are discrete outputs. Accordingly, voltage values V(t) may be expressed as V1, V2, . . . . Vn. In addition, these may be more generally expressed as S1, S2, . . . . Sn as signals. The data acquisition interval according to the present embodiment is 5 ms.

As described above, even in a case where information regarding the toner stop filling operation cannot be detected although the toner stop filling operation has been performed, according to the present embodiment, there may be a case where information regarding the toner stop filling operation can be detected. On the other hand, in a case where the toner filling amount is insufficient, performing drive operation after detecting information regarding the toner stop filling operation may result in damage to key parts. In view of the foregoing, similarly to the first embodiment, it is desirable that toner remaining amount detection is performed after information regarding the toner stop filling operation is detected, and information indicating that a sufficient amount of toner in the developer storage unit has been detected again.

In the above description, toner containing a large amount of air is assumed to be filled, and the state where the output waveform detected by the toner remaining amount detection sensor 50 largely fluctuates has been described. Even under conditions other than those described above, there are cases where the output waveform detected by the toner remaining amount detection sensor 50 largely fluctuates when the toner stop filling operation is performed using the toner pack 40 that does not contain much air. For example, such a fluctuation can occur in a situation where the user forcefully squeezes the toner pack 40. In addition, in the image forming apparatus 1 having the configuration in which the toner remaining amount detection sensor 50 exists immediately below the replenishment port 32a, such a waveform is naturally detected.

Furthermore, in a case where, due to the positional relationship between the position of the agitation member 34 and the position of the toner remaining amount detection sensor 50, toner cannot be accumulated in the detection region of the toner remaining amount detection sensor 50, this detection method is particularly effective.

In the first and second embodiments, the description has been mainly given assuming that the longer-side-direction position of the toner remaining amount detection sensor 50 differs from the longer-side-direction position of the replenishment port 32a. Nevertheless, in a case where the longer-side-direction position of the toner remaining amount detection sensor 50 is the same as or close to the longer-side-direction position of the replenishment port 32a, i.e., in the case where the toner remaining amount detection sensor 50 exists immediately below the replenishment port 32a, according to the present embodiment, it is possible to further improve detection accuracy. Then, the amount of filled toner can be quantified based on a detection result.

In addition, the detection method according to the present embodiment can also be used in a case where, even after the toner stop filling operation is executed, the toner does not fill up to the detection region of the toner remaining amount detection sensor 50, and the detection method according to the first embodiment cannot be used.

### 1. Toner Stop Filling Determination Method

The upper part of FIG. 15 illustrates an example of a voltage waveform V(t) obtained by converting a light receiving signal of the light receiving unit 53 by the A/D conversion unit 95 when the toner stop filling operation is performed.

The lower part of FIG. 15 illustrates a cross-sectional image diagram in a surface is vertical to the left-right direction of the developer container 32 that includes the toner remaining amount detection sensor 50 at the time Tclose, and a transmissive image diagram illustrating the developer container 32 viewed from the front side.

In the present embodiment, it is assumed that the replenishment port 32a exists at the central part in the longer side direction that is the axial direction of the development roller 31, and the toner remaining amount detection sensor 50 exists immediately below the replenishment port 32a and at a position higher than the configuration of the developer container 32 according to the first and second embodiments. In the first and second embodiments, the toner filling and replenishing path is arranged in such a manner as to avoid the laser light L of the scanner unit 11. On the other hand, in a case where the replenishment port 32a is provided at the central part as in the present embodiment, a configuration is assumed in which, for example, the scanner unit 11 is arranged at an end portion in the axial direction. Alternatively, a configuration may be considered in which an LED array in which a plurality of LEDs is arrayed along the axial direction of the photosensitive drum 21 is employed. In the present embodiment, the axial direction of the photosensitive drum 21 and axial direction of the development roller 31 are substantially parallel to each other.

As indicated by the voltage waveform detected by the toner remaining amount detection sensor 50 that is illustrated in the upper part of FIG. 15, during the period from the time Tstart to the time Tend, the detection region of the toner remaining amount detection sensor 50 is blocked by toner in accordance with toner filling, and there is a timing at which an output value decreases. On the other hand, in the toner stop filling operation, during a period during which a flow rate of toner flowing from the toner pack 40 to the developer container 32 is small, or the toner stop filling operation is stopped, the output value becomes larger. That is, a toner filling amount correlates with a value I obtained by integrating a difference between an output voltage Von, which is an output voltage when almost no toner is present in the detection region of the toner remaining amount detection sensor 50, and a voltage value V(t) over the time from the time Topen to the time Tclose. That is, the following relational expression holds.

$$I = {\int }_{{T}_{open}}^{{T}_{close}} ( {V}_{on} - V ( t ) ) dt$$

Accordingly, in the present embodiment, the detection of information regarding the toner stop filling operation is triggered when the value I obtained by integrating the difference between the sensor output value V and the sensor output value Von over the time from the time Topen to the time Tclose exceeds a threshold value Ith3.

In the description of the above-described embodiments, the voltage value V(t) is described to be continuous, but the actual values acquired are discrete outputs. Accordingly, voltage values V(t) may be described as V1, V2, . . . . Vn. A data acquisition interval according to the present embodiment is 5 ms.

In a case where discrete output values V1, V2, . . . . Vn are considered, a value corresponding to the above-described integrated value I is (Von−V1)+(Von−V2)+ . . . +(Von−Vn)=nVon−(V1+V2+. . . +Vn). When V1+V2+. . . +Vn is defined as VSUM, the above-described expression becomes nVon-VSUM. This value may be compared with a predetermined threshold value, and used as a determination criterion in the detection of the toner stop filling operation. In addition, since the output value Von is a constant, a threshold value depending on “n” is defined as VSUMth3, and this may be compared with VSUM and used as a determination criterion in the detection of the toner stop filling operation.

In the present embodiment, the description has been given of a case where the output value of the toner remaining amount detection sensor 50 is output as a voltage, but a physical amount to be output is not limited to a voltage. For example, the above-described values V1, V2, . . . , and Vn, VSUM, and VSUMth3 may be more generally expressed as S1, S2, . . . , and Sn, SSUM, and SSUMth3 as signals.

As described above, according to the detection method of the present embodiment, in a case where the arrangement position of the toner remaining amount detection sensor 50 in the axial direction is close to or the same as the position of the replenishment port 32a, a toner amount in executing the toner stop filling operation can be quantified.

As described above, according to the detection methods described in the first to third embodiments, even in a state in which rotational driving of the development roller 31 and the agitation member 34 is stopped, it is possible to suitably execute the toner stop filling operation. In addition, it is possible to provide a method that can detect whether sufficient toner exists in the developer container 32 when starting the drive operation for driving the development roller 31, the agitation member 34, and the like that is executed after the toner stop filling operation is detected.

Moreover, needless to say, these determination methods described in the first to third embodiments may be appropriately selected depending on the configuration of an apparatus to which the present disclosure is applied, and various conditions, and these may be used in combination for detection.

Heretofore, the description has been mainly given of a case where drive sources of the development roller 31 and the agitation member 34 are the same, and the description has been given of a method of performing toner stop filling detection in a state in which the driving of the development roller 31 and the agitation member 34 is stopped at the time of the toner stop filling operation. Nevertheless, even in a case where the development roller 31 and the agitation member 34 can be individually driven by separate drive sources, it is naturally possible to stop both drive sources at the time of the toner stop filling operation and perform the detection of information by the toner stop filling operation described in the first to third embodiments. For example, as compared with performing toner filling detection while driving the agitation member 34 at the time of toner filling, performing the detection of information by the toner stop filling operation without driving the agitation member 34 allows sufficient toner filling to be detected earlier.

In addition, in the first to third embodiments, the toner stop filling operation has been described assuming that the toner stop filling operation is performed in a state in which no toner is added to the developer container 32, and the execution of the toner stop filling operation is detected. Nevertheless, the method can be similarly applied as long as the replenishment port 32a, the toner remaining amount detection sensor 50, and the bottom surface of the developer container 32 that toner contacts, i.e., toner surface, are arranged in this order in the direction in which toner leaks downward from the replenishment port 32a. For example, even in a case where toner already exists in the developer container 32, performing the detection described in the first to third embodiments enables detection when toner replenishment is performed in a drive stop state. In a case where only a very small amount of toner exists in the developer container 32 and the rotational driving of each member is started without performing toner replenishment, key parts may be damaged. In this case, by performing the detection as described in the above-described first to third embodiments at the time of toner replenishment, information indicating whether sufficient toner exists in the developer container 32 before the start of the drive operation can be detected. On the other hand, in a case where the toner surface exists on the upstream side of the toner remaining amount detection sensor 50 in the direction in which the toner drops down, the detection region of the toner remaining amount detection sensor 50 is shielded by toner before the start of the toner replenishment operation, and the output value is not changed by the toner replenishment operation. Therefore, the execution of the toner replenishment operation cannot be detected. At the time of execution of the toner replenishment operation, whether toner exists in the detection region of the toner remaining amount detection sensor 50 may be preliminarily detected, and information regarding the toner stop filling operation may be detected only when it is detected that toner exists in the detection region of the toner remaining amount detection sensor 50. The detection of whether toner exists by the toner remaining amount detection sensor 50 may be performed by a light-reception availability detection unit that detects whether light emitted from a light emission element is received by a light receiving element, for example.

According to the present disclosure, it is possible to suitably execute toner replenishment into a developer container while reducing damage to parts.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-054682, filed Mar. 28, 2025, which is hereby incorporated by reference herein in its entirety.

What is claimed is:

1. An image forming apparatus comprising:
an image bearing member;
a rotatable developer bearing member configured to supply a developer to the image bearing member;
a first driving unit configured to rotationally drive the developer bearing member;
a developer storage unit in which the developer bearing member is arranged and the developer is stored;
a rotatable agitation member that is arranged in the developer storage unit, and configured to agitate the developer;
a second driving unit configured to rotationally drive the agitation member;
a developer detection unit arranged in the developer storage unit, and configured to detect information regarding the developer stored in the developer storage unit;
an attachment portion comprising a replenishment port that communicates with the developer storage unit, the attachment portion being configured to detachably receive a replenishment container; and
a control unit configured to control the first driving unit and the second driving unit,
wherein the control unit is configured to execute a replenishment operation for replenishing the developer to the developer storage unit,
wherein, during the replenishment operation, the developer is replenished to the developer storage unit through the replenishment port from the replenishment container attached to the attachment portion,
wherein the replenishment operation is executed in a state in which rotation of the developer bearing member and the agitation member is stopped, without performing a rotational operation of the developer bearing member and the agitation member, and
wherein the control unit is configured, during the replenishment operation, to control the first driving unit and the second driving unit based on the information regarding the developer.

2. The image forming apparatus according to claim 1, wherein the control unit is configured to control the first driving unit and the second driving unit based on information regarding the developer stored in the developer storage unit which is detected during the replenishment operation.

3. The image forming apparatus according to claim 1, wherein the first driving unit and the second driving unit share a common drive source.

4. The image forming apparatus according to claim 2, wherein the developer bearing member is configured to rotate by rotating the agitation member.

5. The image forming apparatus according to claim 1, further comprising:
a movable member configured to move to an open position where the replenishment port is exposed and the developer is able to be replenished from the replenishment container to the developer storage unit, and to a closed position where the replenishment port is shielded and the developer is unable to be replenished from the replenishment container to the developer storage unit,
wherein, during a period from when information indicating that the movable member is located at the closed position is detected to when information indicating that the movable member is located at the open position is detected, the control unit is configured to control the developer detection unit to detect the information regarding the developer.

6. The image forming apparatus according to claim 5, wherein, when the information indicating that the movable member is located at the closed position is detected, the control unit is configured to control the developer detection unit to end detection of the information regarding the developer.

7. The image forming apparatus according to claim 5, wherein, when the information indicating that the movable member is located at the open position is detected, the control unit is configured to control the developer detection unit to start detection of the information regarding the developer.

8. The image forming apparatus according to claim 5, wherein the control unit controls the first driving unit and the second driving unit based on the information regarding the developer that has been detected when the information indicating that the movable member is located at the closed position is detected.

9. The image forming apparatus according to claim 1, wherein the information regarding the developer is a first value that is information regarding an amount of developer stored in the developer storage unit.

10. The image forming apparatus according to claim 9, further comprising:
a storage unit configured to store a first threshold value for the first value,
wherein, in a case where the first value crosses the first threshold value, the control unit is configured to execute a second operation for rotating the agitation member after the replenishment operation that is a first operation.

11. The image forming apparatus according to claim 10, further comprising:
a display unit configured to display the information regarding the developer in the developer storage unit,
wherein, in a case where the first value does not cross the first threshold value, the control unit is configured to control the display unit to display information indicating that the developer has not been replenished to the developer storage unit, or information for prompting replenishment of the developer from the replenishment container to the developer storage unit.

12. The image forming apparatus according to claim 10,
wherein the storage unit is configured to store a second threshold value different from the first threshold value, and
wherein, in a case where the first value crosses the second threshold value in the second operation, the control unit is configured to execute a preparation operation to be executed before an image forming operation for forming an image on a recording material, after the second operation.

13. The image forming apparatus according to claim 12, further comprising:
a display unit configured to display the information regarding the developer in the developer storage unit,
wherein, in a case where the first value does not cross the second threshold value, the control unit is configured to control the display unit to display either information indicating that the developer has not been replenished to the developer storage unit or information for prompting replenishment of the developer from the replenishment container to the developer storage unit.

14. The image forming apparatus according to claim 9,
wherein the developer detection unit includes:
a light entrance portion through which light emitted by the image forming apparatus enters, and
a light exit portion configured to let through the light toward a light receiving unit provided in the image forming apparatus, and
wherein the developer detection unit is configured to detect an output voltage that is the first value corresponding to the light received by the light receiving unit.
